(19) United States
(12) Patent Application Publication
(10) Pub. No.: US 2015/0269904 A1
(43) Pub. Date: Sep. 24, 2015

(54) IMAGE PROCESSING DEVICE AND METHOD THEREOF

(71) Applicant: Novatek Microelectronics Corp., Hsinchu (TW)

(72) Inventor: Wan-Ching Tsai, Taipei City (TW)

(73) Assignee: Novatek Microelectronics Corp., Hsinchu (TW)

(21) Appl. No.: 14/291,016

(22) Filed: May 30, 2014

(30) Foreign Application Priority Data
Mar. 20, 2014 (TW) 103110512

(51) Int. Cl. G09G 5/00

(52) U.S. Cl. CPC G09G 5/006; G09G 2370/00; G09G 2354/00; G09G 2340/00

(57) ABSTRACT

An image processing device and a method thereof are provided, and said device includes a valid bits detector and a compensator. The valid bits detector is configured to detect valid bits of an image input signal thereby outputting a correcting coefficient correspondingly. The compensator is coupled to the valid bits detector to receive the correcting coefficient, bit-compensating for the image input signal according to the correcting coefficient, thereby outputting an image output signal correspondingly.

### CROSS-REFERENCE TO RELATED APPLICATION

This application claims the priority benefit of Taiwan application serial no. 103110512, filed on Mar. 20, 2014. The entirety of the above-mentioned patent application is hereby incorporated by reference herein and made a part of this specification.

### BACKGROUND OF THE INVENTION

1. Field of the Invention

The invention relates to an image processing device, and more particularly, to an image processing device and a method thereof.

2. Description of Related Art

With continuous development of the technology, high resolution monitors have become popular to provide viewers with more image details. For example, a monitor compatible with the High Definition Multimedia Interface (HDMI) standard can display images with a 1920×1080 resolution. A currently popular monitor compatible with 4K resolution can display images with resolutions up to 3840×2160 and 4096×2160. However, various image input/play devices nowadays (e.g., a Digital Versatile Disc (DVD) player, a personal computer (PC), a set-top box (STB)) may only provide an image quality with resolutions of 720×480 or 1920×1080, which are quite different from display resolutions provided by aforesaid displays. On the other hand, a bit depth (e.g., a color depth) provided by the image input/play devices is usually different a bit depth of the display.

Taking the DVD player as an example, the bit depth of an image signal inputted by the DVD player is, for example, 6, 8, 10 bits and so on, whereas the bit depth of an image signal displayed/outputted by the display (e.g., a television) connected to the DVD player is, for example, 8, 10, 12 bits and so on. In case the bit depth (e.g., 6 bits) of the image signal inputted to the display is smaller than a rated bit depth (e.g., 10 bits) of the display, because a mismatch of 4 bits is present between valid bits of the inputted image signal and the rated bit depth of the display, a “false contour” phenomenon is usually found at gradual change regions (e.g., edges of the image) of an image frame. Accordingly, images on the gradual change regions may be rougher and not smooth, which affects viewing perception of a user with respect to the displayed image.

### SUMMARY OF THE INVENTION

The invention is directed to an image processing device and a method thereof, capable of detecting valid bits of an image input signal, and performing a bit depth compensation to the image input signal, so as to effectively improve a display quality of the image frame being displayed.

The invention provides an image processing device, and said device includes a valid bits detector and a compensator. The valid bits detector is configured to detect valid bits of an image input signal thereby outputting a correcting coefficient correspondingly. The compensator is coupled to the valid bits detector to receive the correcting coefficient, bit-compensating for the image input signal according to the correcting coefficient, thereby outputting an image output signal correspondingly.

The invention provides an image processing method adapted to an image processing device, and said method includes the following steps: detecting valid bits of an image input signal, thereby generating a correcting coefficient correspondingly; and bit-compensating for the image input signal according to the correcting coefficient, thereby generating an image output signal correspondingly.

In an embodiment of the invention, the valid bits detector includes a signal counting unit, an auto-correlation unit and a quantization detector. The signal counting unit counts a luma value of the image input signal, and outputs a luma counting result. The auto-correlation unit is coupled to the signal counting unit, and configured to transfer the luma counting result into an auto-correlation curve. The quantization detector is coupled to the auto-correlation unit, and configured to calculate the correcting coefficient according to the auto-correlation curve and output the correcting coefficient to the compensator.

In an embodiment of the invention, the auto-correlation unit transfers the luma counting result into the auto-correlation curve according to a correlation function.

In an embodiment of the invention, the quantization detector locates a peak position of the auto-correlation curve, performs a high pass filtering to the auto-correlation curve to obtain a filtered curve, and calculates the correcting coefficient according to an auto-correlation value of the auto-correlation curve and a filter value of the filtered curve respectively at the peak position.

In an embodiment of the invention, the quantization detector transfers an auto-correlation value of the auto-correlation curve at the peak position into a first temporary parameter, transfers a filter value of the filtered curve at the peak position into a second temporary parameter, and calculates the correcting coefficient according to the first temporary parameter and the second temporary parameter.

In an embodiment of the invention, the quantization detector multiplies the first temporary parameter by the second temporary parameter to obtain the correcting coefficient.

In an embodiment of the invention, the valid bits detector includes a signal counting unit, an auto-correlation unit and a quantization detector. The signal counting unit counts a luma value of the image input signal, and outputs a luma counting result. The auto-correlation unit is coupled to the signal counting unit, and configured to transfer the luma counting result into an auto-correlation curve. The quantization detector is coupled to the auto-correlation unit, and configured to calculate an initial correcting coefficient according to the auto-correlation curve. The graphic meter is coupled to the quantization detector to receive the initial correcting coefficient, configured to perform an edge detection to a plurality of pixels in an image frame of the image input signal and calculate the correcting coefficient according to the initial correcting coefficient and a result of the edge detection of the pixels.

In an embodiment of the invention, the quantization detector locates a peak position of the auto-correlation curve, performs a high pass filtering to the auto-correlation curve to obtain a filtered curve, transfers an auto-correlation value of the auto-correlation curve at the peak position into a first temporary parameter, transfers a filter value of the filtered curve at the peak position into a second temporary parameter, and calculates the initial correcting coefficient according to the first temporary parameter and the second temporary parameter.

In an embodiment of the invention, the edge detection includes: calculating a total of a first adjacent pixel groups of a current pixel among the pixels on a first direction to be used as a first adjacent pixel sum; calculating a total of a second adjacent pixel groups of the current pixel on a second direction to be used as a second adjacent pixel sum, wherein the first direction and the second direction have a difference of 180 degree; calculating a difference between the first adjacent pixel sum and the second adjacent pixel sum to be used as a first edge value of the current pixel; counting a first correcting gain of the pixels according to a relation between the first edge values of the pixels and the initial correcting coefficient; calculating a total of a third adjacent pixel groups of the current pixel on a third direction to be used as a third adjacent pixel sum; calculating a total of a fourth adjacent pixel groups of the current pixel on a fourth direction to be used as a fourth adjacent pixel sum, wherein the third direction and the fourth direction have a difference of 180 degree; calculating a difference between the third adjacent pixel sum and the fourth adjacent pixel sum to be used as a second edge value of the current pixel; counting a second correcting gain of the pixels according to a relation between the second edge values of the pixels and the initial correcting coefficient; and using the first correcting gain and the second correcting gain to be used as the result of the edge detection.

In an embodiment of the invention, the correcting coefficient is calculated by obtaining a result from multiplying the initial correcting coefficient by the first correcting gain and the second correcting gain, so as to obtain the correcting coefficient.

In an embodiment of the invention, the compensator includes a first false contour reduction device and a second false contour reduction device. The first false contour reduction device is configured to receive the image input signal and perform a first false contour reduction to the image input signal according to the correcting coefficient, so as to output a first image correcting signal. The second false contour reduction device is coupled to the first false contour reduction device, configured to receive the first image correcting signal and perform a second false contour reduction to the first image correcting signal according to the correcting coefficient, so as to output the image output signal.

In an embodiment of the invention, the first false contour reduction device includes a horizontal filtering unit, a dithering unit, a horizontal edge detecting unit and a blending unit. The horizontal filtering unit is configured to determine whether a difference between a current pixel in the image input signal and an adjacent pixel on a horizontal direction is greater than the correcting coefficient, thereby correspondingly outputting a filtered signal according to a determining result. The dithering unit is coupled to the horizontal filtering unit, and configured to receive the filtered signal and perform a dithering operation to the filtered signal, so as to output a dithered signal. The horizontal edge detecting unit is configured to receive the image input signal and a chroma signal and detect a horizontal edge according to the image input signal and the chroma signal, thereby deciding a horizontal valid value. The mixing unit is coupled to the dithering unit and the horizontal edge detecting unit, configured to perform a weight calculation to the image input signal and the dithered signal, so as to output the first image correcting signal, wherein the mixing unit decides weights of the image input signal and the dithered signal according to the horizontal valid value.

In an embodiment of the invention, the horizontal edge detecting unit calculates a horizontal edge level according to the chroma signal and the image input signal, and compares the horizontal edge level with a plurality of horizontal edge thresholds, so as to quantize the horizontal edge level to obtain the horizontal valid value.

In the present embodiment, the image input signal includes a luma signal and a chroma signal. The chroma signal includes a red chroma signal and a blue chroma signal. The horizontal edge detecting unit selects the largest one among the horizontal gradient of the luma signal, the horizontal gradient of the red chroma signal and the horizontal gradient of the blue chroma signal to be used as the horizontal edge level.

In an embodiment of the invention, the second false contour reduction device includes a vertical filtering unit, a dithering unit, a vertical edge detecting unit and a blending unit. The vertical filtering unit is configured to determine whether a difference between a current pixel in the first image correcting signal and an adjacent pixel along a vertical direction is greater than the correcting coefficient, thereby correspondingly outputting a filtered signal according to a determining result. The dithering unit is coupled to the vertical filtering unit, and configured to receive the filtered signal and perform a dithering operation to the filtered signal, so as to output a dithered signal. The vertical edge detecting unit is configured to receive the first image correcting signal and a chroma signal and detect a vertical edge according to the first image correcting signal and the chroma signal, thereby deciding a vertical valid value. The mixing unit is coupled to the dithering unit and the vertical edge detecting unit, configured to perform a weight calculation to the first image correcting signal and the dithered signal, so as to output the image output signal, wherein the mixing unit decides weights of the first image correcting signal and the dithered signal according to the vertical valid value.

In an embodiment of the invention, a buffer unit is also included, which is configured to buffer the image input signal for synchronizing the image input signal with the correcting coefficient and inputting the buffered image input signal to the compensator.

Based on above, in the image processing device and the method thereof as proposed according to the invention, the valid bits detector in the image processing device may detect the valid bits of the image input signal, and perform processes and calculations to the image input signal, so as to output the obtained correcting coefficient to the compensator. As a result, the compensator may bit-compensate for insufficient bit depth of the image input signal according to the correcting coefficient, thereby effectively improving a display quality of the image frame being displayed while avoiding occurrences of the false contour phenomenon.

To make the above features and advantages of the disclosure more comprehensible, several embodiments accompanied with drawings are described in detail as follows.

### BRIEF DESCRIPTION OF THE DRAWINGS

FIG. 1 is a block diagram illustrating an image processing device according to an embodiment of the invention.

FIG. 2 is a block diagram illustrating inside of a valid bits detector and a compensator according to an embodiment of the invention.

FIG. 3 is a luma histogram outputted by a signal counting unit according to an embodiment of the invention.

FIG. 4 is an auto-correlation curve outputted by an auto-correlation unit according to an embodiment of the invention.

FIG. 5 is an auto-correlation strength curve outputted by a quantization detector according to an embodiment of the invention.

FIGS. 6a and 6b are look up tables of the quantization detector according to an embodiment of the invention.

FIG. 7 is a schematic diagram of a plurality of pixels in an image frame of an image input signal according to an embodiment of the invention.

FIGS. 8a and 8b are schematic diagrams illustrating a method of comparing the pixels according to an embodiment of the invention.

FIGS. 9a and 9b are look up tables of a graphic meter according to an embodiment of the invention.

FIG. 10 is a block diagram illustrating inside of a first false contour reduction device according to an embodiment of the invention.

FIG. 11 is a look up table of a horizontal edge detecting unit according to an embodiment of the invention.

FIG. 12 is a block diagram illustrating inside of a second false contour reduction device of FIG. 2 according to an embodiment of the invention.

FIG. 13 is a look up table of a vertical edge detecting unit according to an embodiment of the invention.

FIG. 14 is a block diagram illustrating internal circuits of the valid bits detector and the compensator according to another embodiment of the invention.

FIG. 15 is a flowchart of an image processing method according to an embodiment of the invention.

FIG. 16 is a flowchart of step S100 in FIG. 15 according to an embodiment of the invention.

FIG. 17 is a flowchart of step S130 in FIG. 16 according to an embodiment of the invention.

FIG. 18 is a flowchart of step S136 in FIG. 17 according to an embodiment of the invention.

FIG. 19 is a flowchart of step S100 in FIG. 15 according to another embodiment of the invention.

FIG. 20 is a flowchart of step S1930 in FIG. 19 according to an embodiment of the invention.

FIG. 21 is a flowchart of step S1940 in FIG. 19 according to an embodiment of the invention.

FIG. 22 is a flowchart of step S1944 in FIG. 21 according to an embodiment of the invention.

FIG. 23 is a flowchart of step S200 in FIG. 15 according to an embodiment of the invention.

FIG. 24 is a flowchart of step S210 in FIG. 23 according to an embodiment of the invention.

FIG. 25 is a flowchart of step S216 in FIG. 24 according to an embodiment of the invention.

FIG. 26 is a flowchart of step S220 in FIG. 23 according to an embodiment of the invention.

### DESCRIPTION OF THE EMBODIMENTS

Descriptions of the invention are given with reference to the exemplary embodiments illustrated with accompanied drawings, in which same or similar parts are denoted with same reference numerals. Moreover, elements/components/notations with same reference numerals represent same or similar parts in the drawings and embodiments.

FIG. 1 is a block diagram illustrating an image processing device according to an embodiment of the invention. Referring to FIG. 1, an image processing device 100 includes a valid bits detector 110 and a compensator 120, but the invention is not limited thereto. The valid bits detector 110 is configured to detect valid bits in a bit depth of an image input signal Y_in thereby outputting a correcting coefficient Q_final correspondingly. The compensator 120 is coupled to the valid bits detector 110 for receiving the correcting coefficient Q_final, bit-compensating for the image input signal Y_in according to the correcting coefficient Q_final, thereby outputting an image output signal Y_out correspondingly.

In the present embodiment, the image processing device 100 may be applied between an image input device (not illustrated, such as a DVD player and so on) and a display (not illustrated, such as a television and so on), but the invention is not limited thereto. The image processing device 100 is capable of bit-compensating for the image input signal Y_in provided by the image input device, thereby outputting the image output signal Y_out which matches a rated bit depth of the display. Accordingly, occurrences of the false contour phenomenon in the image processing device 100 may be reduced.

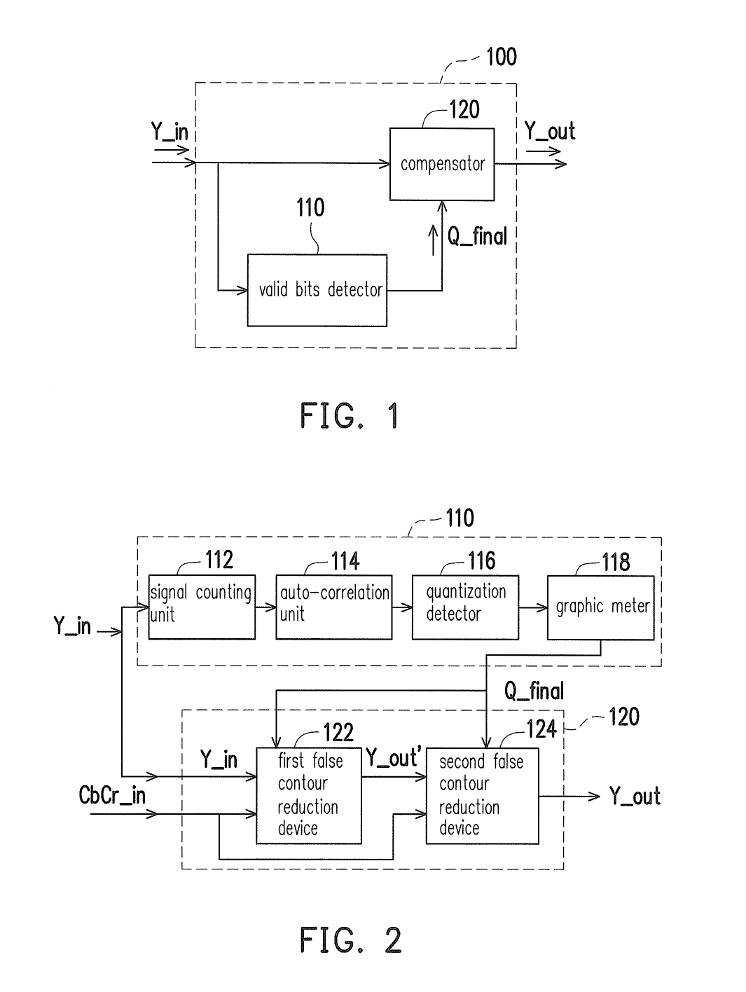

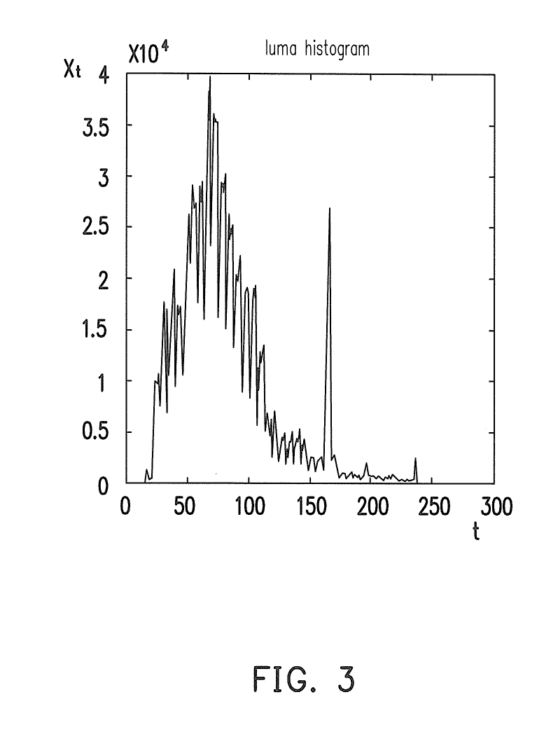

FIG. 2 is a block diagram illustrating inside of a valid bits detector and a compensator according to an embodiment of the invention. The embodiment depicted in FIG. 2 may be inferred with reference to related description for FIG. 1. Referring to FIG. 2, the valid bits detector 110 of present embodiment includes a signal counting unit 112, an auto-correlation unit 114 and a quantization detector 116, but the invention is not limited thereto. The signal counting unit 112 is configured to count a luma value of the image input signal Y_in, and output a luma counting result. The luma counting result may be recorded and represented in any manners. For example, in some embodiments, the luma counting result may include a luma histogram as shown in FIG. 3. FIG. 3 is a luma histogram outputted by a signal counting unit according to an embodiment of the invention, wherein a horizontal axis t represents the luma value in the luma histogram, and a vertical axis Xₜ represents a number of pixels having the luma value t in one image frame. More specifically, the signal counting unit 112 obtains the luma histogram by respectively counting the number of pixels having different luma values (i.e., gray-scale values) in the image input signal Y_in.

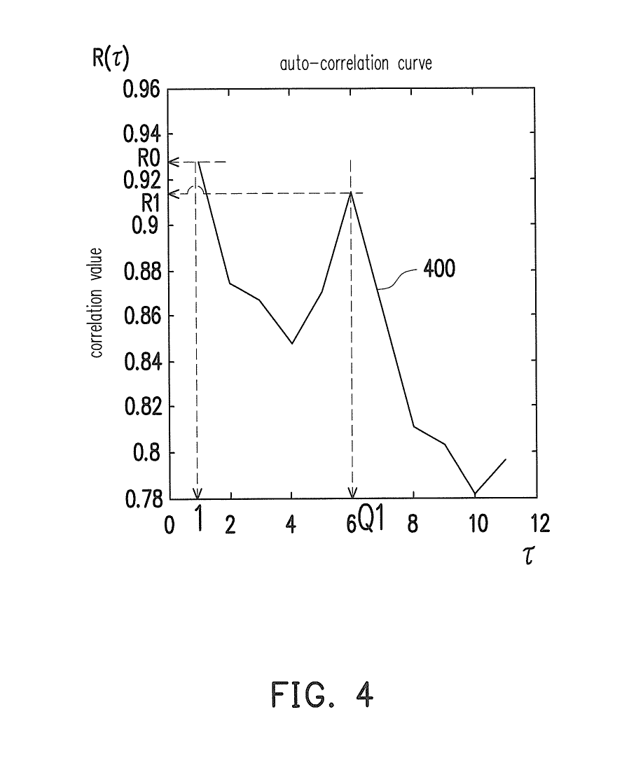

Next, referring back to FIG. 2, the auto-correlation unit 114 in the valid bits detector 110 is coupled to the signal counting unit 112, and configured to transfer the luma counting result depicted in FIG. 3 into an auto-correlation curve 400, as shown in FIG. 4. FIG. 4 is an auto-correlation curve outputted by an auto-correlation unit according to an embodiment of the invention. In FIG. 4, a horizontal axis τ represents a luma span length in the luma histogram, and a vertical axis R(τ) refers to a correlation between two luma values having the luma span length T.

In an embodiment, the auto-correlation unit 114 may transfer the luma counting result outputted by the signal counting unit 112 into the auto-correlation curve 400 according to a correlation function. The luma counting result may include the luma histogram, and the correlation function is provided as follows (but not limited thereto):

$$R ( τ ) = \frac{{\sum }_{t} ( {X}_{t} \cdot {X}_{t + τ} )}{{\sum }_{t} ( {X}_{t}^{2} )}$$

Therein, t refers to the luma value in the luma histogram, Xₜ refers to a number of pixels having the luma value t, and X_{t+τ} refers to a number of pixels having the luma value t+τ in the luma histogram.

In another embodiment, the correlation function is as follows:

$$R ( τ ) = \frac{{\sum }_{t} [ ( {X}_{t} - μ ) \cdot ( {X}_{t + τ} - μ ) ]}{{\sum }_{t} ( {X}_{t}^{2} - {μ}^{2} )}$$

Therein, t refers to the luma value in the luma histogram, Xₜ refers to a number of pixels having the luma value t, X_{t+τ} refers to a number of pixels having the luma value t+τ, and μ refers to an average of all Xₜ in the luma histogram. However, the implementation of the auto-correlation unit 144 is not limited by aforesaid description regarding the correlation function of the present embodiment.

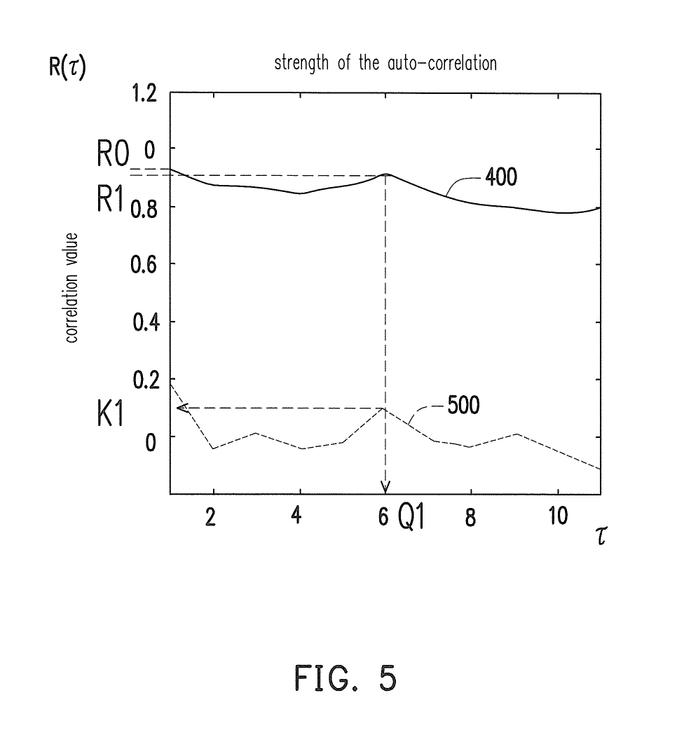

Referring back to FIG. 2, the quantization detector 116 is coupled to the auto-correlation unit 114, and configured to calculate an initial correcting coefficient Q according to the auto-correlation curve 400 outputted by the auto-correlation unit 114. For instance, the quantization detector 116 locates a peak position of the auto-correlation curve 400 corresponding to the vertical axis (e.g., positions 1 and Q1 of peaks R0 and R1 in FIG. 4), and performs a high pass filtering to the auto-correlation curve 400 to obtain a filtered curve 500, as shown in FIG. 5. FIG. 5 is an auto-correlation strength curve outputted by a quantization detector according to an embodiment of the invention. In FIG. 5, a horizontal axis τ represents a luma span length in the luma histogram, and a vertical axis R(τ) refers to a correlation between two luma values having the luma span length r. A curve 400 depicted in FIG. 5 is a part of the curve 400 depicted in FIG. 4. The quantization detector 116 may calculate the initial correcting coefficient Q according to the auto-correlation value R1 of the auto-correlation curve 400 and the filter value K1 of the filtered curve 500 respectively at the peak position Q1. An example of calculating the initial correcting coefficient Q may refer to the following description, but not limited thereto.

For instance, the quantization detector 116 may transfer an auto-correlation value R1 of the auto-correlation curve 400 at the peak position Q1 into a first temporary parameter Q_tmp1, and transfers a filter value K1 of the filtered curve 500 at the peak position Q1 into a second temporary parameter Q_tmp2. After the first temporary parameter Q_tmp1 and the second temporary parameter Q_tmp2 are obtained, the quantization detector 116 may calculates the initial correcting coefficient Q according to the first temporary parameter Q_tmp1 and the second temporary parameter Q_tmp2.

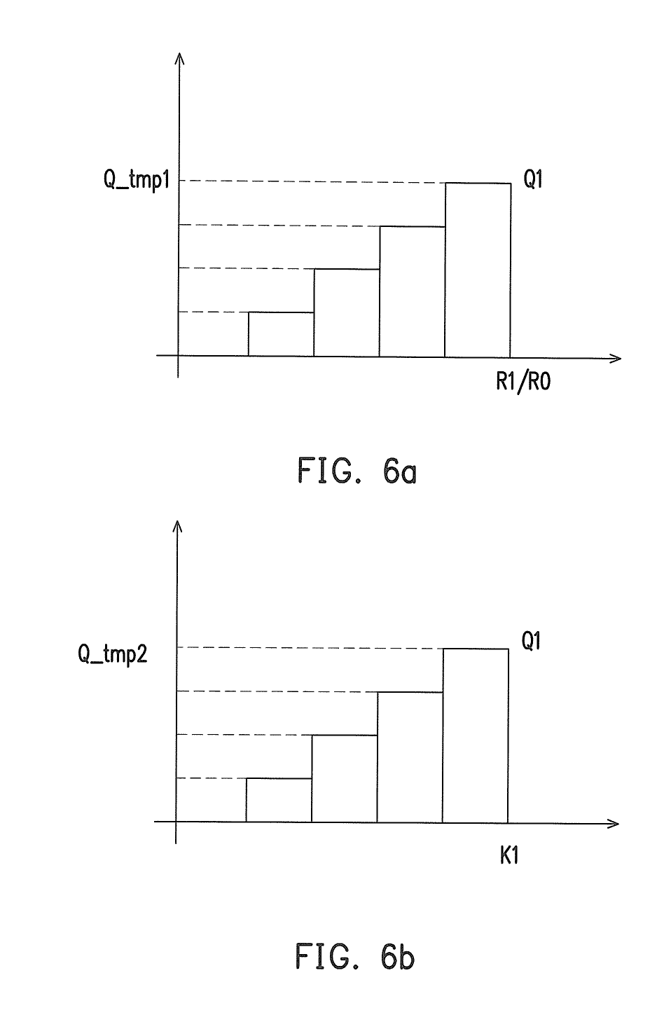

FIG. 6a is a look up table of the quantization detector according to an embodiment of the invention. In FIG. 6a, a horizontal axis represents the auto-correlation value of the auto-correlation curve 400, and a vertical axis represents the first temporary parameter Q_tmp1. In the present embodiment, the quantization detector 116 may transfer the auto-correlation value (e.g., R0, R1) of the auto-correlation curve 400 at the peak position (e.g., 1, Q1) into a first temporary parameter Q_tmp1 according to a transferring relation depicted in FIG. 6a. More specifically, the quantization detector 116 may use the auto-correlation value R0 of the luma span length τ=1 as a reference value, so as to normalize the auto-correlation value R1 of the auto-correlation curve 400 at the peak position Q1 to obtain a normalized value (e.g., R1/R0, and the auto-correlation values of other positions may be deduced by analogy). As a result, a table look-up may be performed according the normalized value to transfer the normalized value into the first temporary parameter Q_tmp1, as shown in FIG. 6a. However, the calculation regarding the auto-correlation value is not limited only to the above.

FIG. 6b is a look up table of the quantization detector according to an embodiment of the invention. In FIG. 6a, a horizontal axis represents the filter value of the filtered curve 500, and a vertical axis represents the second temporary parameter Q_tmp2. Referring to FIG. 6b, the quantization detector 116 may also perform the table look-up for the corresponding filter value (e.g., K1) of the filtered curve 500 at the peak position (e.g., Q1) by using a transferring relation depicted in FIG. 6b, so as to obtain the second temporary parameter Q_tmp2.

After the first temporary parameter Q_tmp1 and the second temporary parameter Q_tmp2 are obtained, the quantization detector 116 may calculates the initial correcting coefficient Q according to the first temporary parameter Q_tmp1 and the second temporary parameter Q_tmp2. In an embodiment, the quantization detector 116 may multiply the first temporary parameter Q_tmp1 by the second temporary parameter Q_tmp2 to obtain the initial correcting coefficient Q (e.g., Q=Q_tmp1*Q_tmp2). However, in other embodiments, the calculation of the initial correcting coefficient Q is not limited to the above.

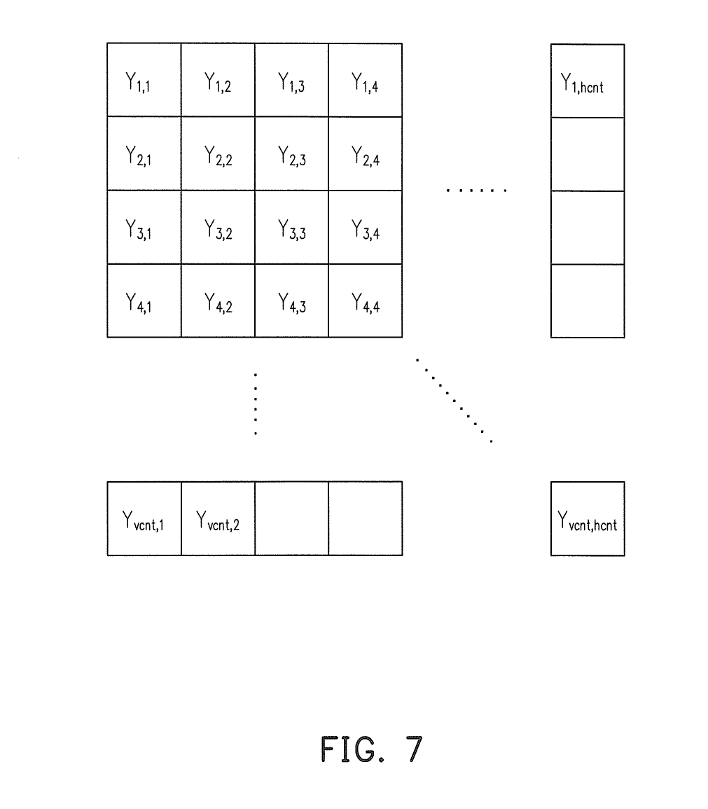

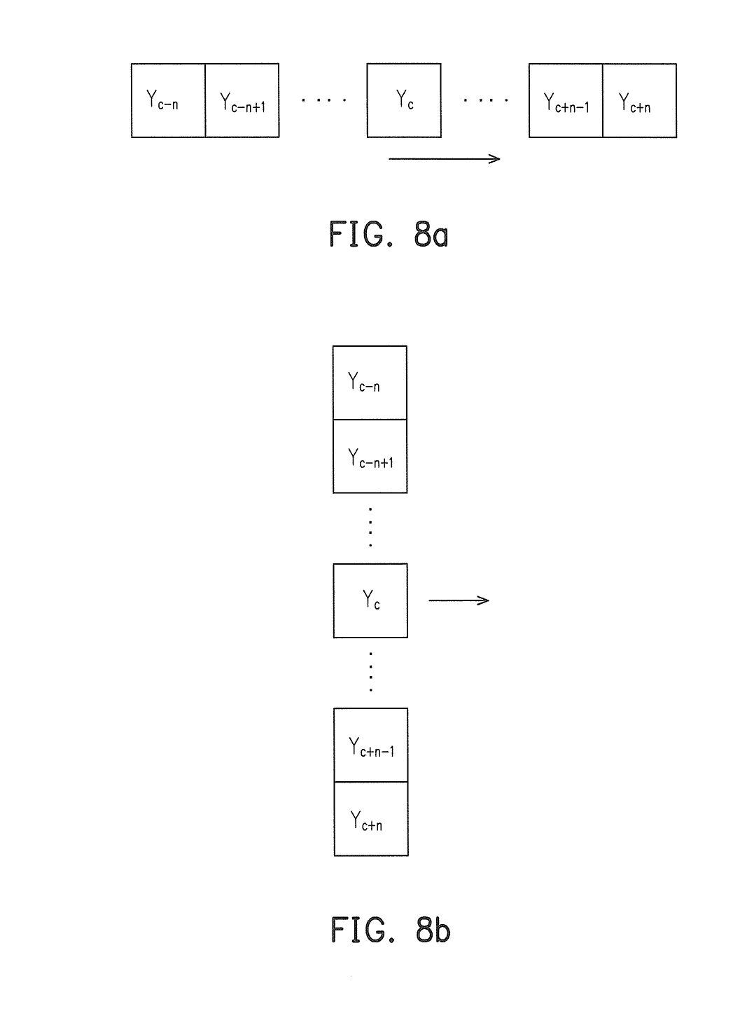

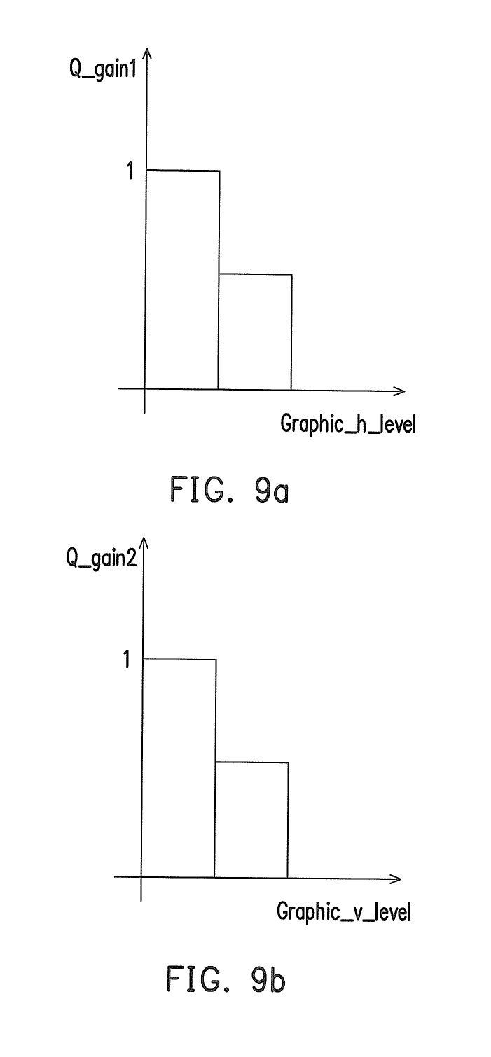

Referring back to FIG. 2, in an embodiment, the valid bits detector 110 may further include a graphic meter 118, as shown in FIG. 2. The graphic meter 118 is coupled to the quantization detector 116 to receive the initial correcting coefficient Q, configured to perform an edge detection (which will be described in details later) to a plurality of pixels in an image frame of the image input signal Y_in and calculate the correcting coefficient Q_final according to the initial correcting coefficient Q and a result of the edge detection of the pixels. Accordingly, whether the image input signal belongs to a nature image or a graphic image may be further identified, so as to avoid misjudgment of the false contour. In the present embodiment, the graphic meter 118 may be disposed in the valid bits detector 110 or built in the quantization detector 116, but not limited thereto. Detailed description regarding specific implementation of the edge detection is provided by reference with FIG. 7, FIG. 8a, FIG. 8b and FIG. 9.

FIG. 7 is a schematic diagram of a plurality of pixels in an image frame of an image input signal Y_in according to an embodiment of the invention. The image input signal Y_in includes luma values Y_{1,1}, Y_{1,2}, . . . Y_{1,hcnt}, . . . , Y_{2,1}, Y_{2,2}, . . . , Y_{vcnt,1}, Y_{vcnt,2}, . . . , Y_{vcnt,hcnt} of the pixels in a current image frame, in which each of the pixels is arranged from left to right and from bottom to top as shown in FIG. 7, but the invention is not limited thereto.

FIGS. 8a and 8b are schematic diagrams illustrating a method of comparing the pixels according to an embodiment of the invention. The graphic meter 118 may scan the pixels in the image frame of the image input signal Y_in one by one, and perform the edge detection according to the method depicted in FIG. 8a and/or FIG. 8b during scanning of the image frame. More specifically, an operation method of the edge detection may include the following steps. First, the graphic meter 118 may scan the luma values Y_{1,1} to Y_{vcnt,hcnt} of the pixels in the image frame of the image input signal Y_in one by one. It is assumed that the pixel with the luma value currently scanned is Y_{c}.

Referring to FIG. 8a, the graphic meter 118 calculates a total of a first adjacent pixel groups Y_{c-n}, Y_{c-n+1}, . . . , Y_{c-1} of the current pixel Y_{c} among the pixels on a first direction to be used as a first adjacent pixel sum

$${\sum }_{i = 1}^{n} {Y}_{c - i} .$$

In the present embodiment, the first direction is a row direction, but the invention is not limited thereto. Subsequently, the graphic meter 118 calculates a total of a second adjacent pixel groups Y_{c+1}, . . . , Y_{c+n-1}, Y_{c+n} of the current pixel Y_{c} on a second direction to be used as a second adjacent pixel sum

$${\sum }_{i = 1}^{n} {Y}_{c + i} ,$$

wherein the first direction and the second direction have a difference of 180 degree. The graphic meter 118 may calculate a difference between the first adjacent pixel sum

$${\sum }_{i = 1}^{n} {Y}_{c - i}$$

and the second adjacent pixel sum

$${\sum }_{i = 1}^{n} {Y}_{c + i}$$

to be used as a first edge value of the current pixel Y_{c}.

Referring to FIG. 8b, the graphic meter 118 may calculate a total of a third adjacent pixel groups Y_{c-n}, Y_{c-n+1}, . . . , Y_{c-1} of the current pixel Y_{c} on a third direction to be used as a third adjacent pixel sum

$${\sum }_{i = 1}^{n} {Y}_{c - i} .$$

In the present embodiment, the third direction is a column direction, but the invention is not limited thereto. Subsequently, the graphic meter 118 calculates a total of a fourth adjacent pixel groups Y_{c+1}, Y_{c+n-1}, Y_{c+n} of the current pixel Y_{c} on a fourth direction to be used as a fourth adjacent pixel sum

$${\sum }_{i = 1}^{n} {Y}_{c + i} ,$$

wherein the third direction and the fourth direction have a difference of 180 degree. The graphic meter 118 may calculate a difference between the third adjacent pixel sum

$${\sum }_{i = 1}^{n} {Y}_{c - i}$$

and the fourth adjacent pixel sum

$${\sum }_{i = 1}^{n} {Y}_{c + i}$$

to be used as a second edge value of the current pixel Y_{c}.

Take FIG. 7 for example, it is assumed that the pixel with the luma value currently scanned is Y_{x,y}, wherein 1≦x≦vcnt; 1≦y≦hcnt; and vcnt and hcnt are integers. As inferred with reference to FIG. 8a and FIG. 8b and assuming that a distance n between the adjacent pixel groups is 4, the current pixel Y_{x,y} in the image frame depicted in FIG. 7 has a first adjacent pixel sum being

$${\sum }_{j = y - 4}^{y - 1} {Y}_{x , j}$$

and a second adjacent pixel sum being

$${\sum }_{j = y + 1}^{y + 4} {Y}_{x , j} .$$

The graphic meter 118 may calculate a difference between the first adjacent pixel sum

$${\sum }_{j = y - 4}^{y - 1} {Y}_{x , j}$$

and the second adjacent pixel sum

$${\sum }_{j = y + 1}^{y + 4} {Y}_{x , j}$$

to be used as a first edge value Yhdiff_{x,y} of the current pixel Y_{x,y}. For instance,

$${Yhdiff}_{x , y} = \vert {\sum }_{j = y - 4}^{y - 1} {Y}_{x , j} - {\sum }_{j = y + 1}^{y + 4} {Y}_{x , j} \vert .$$

Similarly, the current pixel Y_{x,y}, in the image frame depicted in FIG. 7 includes a third adjacent pixel sum being

$${\sum }_{i = x - 4}^{x - 1} {Y}_{i , y}$$

and a fourth adjacent pixel sum being

$${\sum }_{i = x + 1}^{x + 4} {Y}_{i , y} .$$

The graphic meter 118 may calculate a difference between the third adjacent pixel sum

$${\sum }_{i = x - 4}^{x - 1} {Y}_{i , y}$$

and the fourth adjacent pixel sum

$${\sum }_{i = x + 1}^{x + 4} {Y}_{i , y}$$

to be used as a second edge value Yvdiff_{x,y} of the current pixel Y_{x,y}. For instance,

$${Yvdiff}_{x , y} = \vert {\sum }_{i = x - 4}^{x - 1} {Y}_{i , y} - {\sum }_{i = x + 1}^{x + 4} {Y}_{i , y} \vert .$$

Thereafter, the graphic meter 118 may count a first correcting gain Q_gain1 of the pixels according to a relation between the first edge values (e.g., the first edge value Yhdiff_{x,y} of the pixel Y_{x,y}) of all the pixels in the image frame and the initial correcting coefficient Q. An example for calculating the first correcting gain Q_gain1 may refer to the followings, but the invention is not limited thereto. More specifically, a method for the graphic meter 118 to count the first correcting gain Q_gain1 includes the following steps. First, the graphic meter 118 may count, from among the pixels in the image frame, a number of pixels located on the same row and having the first edge value greater than a first threshold N and less than k times the initial correcting coefficient Q to be used as a horizontal edge pixels number of the same row, wherein k is a real number (e.g., 4 or other numbers). For instance, the graphic meter 118 may count the horizontal edge pixels number of an i^{th} row in the image frame depicted in FIG. 7 being contour_h_cntᵢ. A counting method of the horizontal edge pixels number contour_h_cntᵢ of the i^{th} row is described in pseudo codes as follows (and the rest may be deduced by analogy):

contour_h_cntᵢ=0;
for (j = 1; j≦hcnt, j++)
{

if ((Yhdiff_{i,j}>N) and (Yhdiff_{i,j}< k*Q))
{

contour_h_cntᵢ++;

}

}

Subsequently, the graphic meter 118 may count, from among a plurality of rows in the image fame, a number of rows having a difference between the horizontal edge pixels number of the same row and the horizontal edge pixels number of an adjacent row being less than a second threshold th_h to be used as a horizontal edge rows number Graphic_h_level. For instance, the graphic meter 118 may check and count the horizontal edge pixels number contour_h_cnt₁ to contour_h_cnt_{vcnt} from a first row to a vcnt^{th} row in the image frame depicted in FIG. 7, so as to obtain the horizontal edge rows number Graphic_h_level of the image frame depicted in FIG. 7. A counting method of the horizontal edge rows number Graphic_h_level is described in pseudo codes as follows:

Graphic_h_level=0;
for (i = 1; i≦vcnt, i++)
{

if (|contour_h_cntᵢ − contour_h_cntᵢ₊₁| <th_h)
{

Graphic_h_level ++;

}

}

Lastly, the graphic meter 118 may perform the table look-up for the horizontal edge rows number Graphic_h_level, so as to transfer the horizontal edge rows number Graphic_h_level to correspondingly obtain the first correcting gain Q_gain1, as shown in FIG. 9a. FIG. 9a is a look up table of a graphic meter according to an embodiment of the invention. In FIG. 9a, a horizontal axis represents the horizontal edge rows number Graphic_h_level, and a vertical axis represents the first correcting gain Q_gain1. The graphic meter 118 may perform the table look-up to transfer the horizontal edge rows number Graphic_h_level into the first correcting gain Q_gain1 according to a transferring relation depicted in FIG. 9a.

Similarly, the graphic meter 118 may count a second correcting gain Q_gain2 of the pixels according to a relation between the second edge values (e.g., the second edge value Yvdiff_{x,y} of the pixel Y_{x,y}) of all the pixels in the image frame and the initial correcting coefficient Q. An example for calculating the second correcting gain Q_gain2 may refer to the followings, but the invention is not limited thereto. First, the graphic meter 118 may count, from among the pixels in the image frame, a number of pixels located on the same row and having the second edge value greater than the first threshold N and less than k times the initial correcting coefficient Q to be used as a vertical edge pixels number of the same row, wherein k is a real number (e.g., 4 or other numbers). For instance, the graphic meter 118 may count the vertical edge pixels number contour_v_cntᵢ of an i^{th} row in the image frame depicted in FIG. 7. A counting method of the vertical edge pixels number contour_v_cntᵢ of the i^{th} row is described in pseudo codes as follows (and the rest may be deduced by analogy):

contour_v_cntᵢ=0;
for (j = 1; j≦hcnt, j++)
{

if ((Yvdiff_{i,j}> N) and (Yvdiff_{i,j}< k*Q))
{

contour_v_cntᵢ++;

}

}

Next, the graphic meter 118 may count, from among a plurality of rows in the image frame, a number of rows having a difference between the vertical edge pixels number of the same row and the vertical edge pixels number of an adjacent row being less than a second threshold th_h to be used as a vertical edge rows number Graphic_v_level. For instance, the graphic meter 118 may check and count the numbers of pixels at the vertical edge contour_v_cnt₁ to contour_v_cnt_{vcnt} from a first row to a vcnt^{th} row in the image frame depicted in FIG. 7, so as to obtain the vertical edge rows number Graphic_v_level. A counting method of the vertical edge rows number Graphic_v_level is described in pseudo codes as follows:

Graphic_v_level=0;
for (i = 1; i≦vcnt, i++)
{

if (|contour_v_cntᵢ − contour_v_cntᵢ₊₁| <th_h)
{

Graphic_v_level ++;

}

}

The graphic meter 118 may perform the table look-up for the vertical edge rows number Graphic_v_level, so as to transfer the vertical edge rows number Graphic_v_level to correspondingly obtain the second correcting gain Q_gain2, as shown in FIG. 9b. FIG. 9b is a look up table of a graphic meter according to an embodiment of the invention. In FIG. 9b, a horizontal axis represents the vertical edge rows number Graphic_v_level, and a vertical axis represents the second correcting gain Q_gain2. The graphic meter 118 may perform the table look-up to transfer the vertical edge rows number Graphic_v_level into the second correcting gain Q_gain2 according to a transferring relation depicted in FIG. 9b. For the graphic meter 118, the method for calculating the second correcting gain Q_gain2 adopts a calculation similar to the method for calculating the first correcting gain Q_gain1, except the direction used by the graphic meter 118 to perform the edge detection for the pixels in the image frame of the image input signal Y_in is a direction of the vertical axis, that is, the column direction.

After the first correcting gain Q_gain1 and the second correcting gain Q_gain2 are obtained, the graphic meter 118 may use the first correcting gain Q_gain1 and the second correcting gain Q_gain2 to be used as the result of the edge detection. In an embodiment, the correcting coefficient Q_final is calculated by: obtaining a result from multiplying the initial correcting coefficient Q by the first correcting gain Q_gain1 and the second correcting gain Q_gain2, so as to obtain the correcting coefficient Q_final. For example, Q_final=Q*Q_gain1*Q_gain2. However, a calculation for the correcting coefficient Q_final is not limited only to the above.

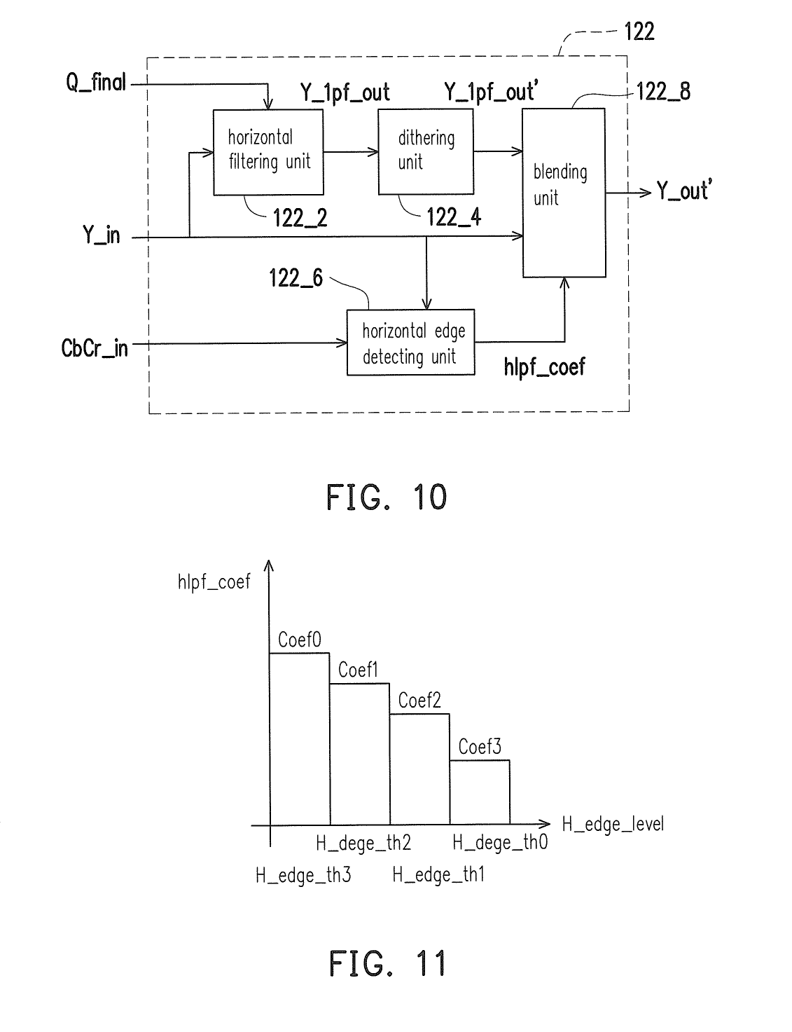

On the other hand, referring back to FIG. 2, in the present embodiment, the compensator 120 includes a first false contour reduction device 122 and a second false contour reduction device 124. The first false contour reduction device 122 is configured to receive the image input signal Y_in and perform a first false contour reduction to the image input signal Y_in according to the correcting coefficient Q_final, so as to output a first image correcting signal Y_out′. The second false contour reduction device 124 is coupled to the first false contour reduction device 122, configured to receive the first image correcting signal Y_out′ and perform a second false contour reduction to the first image correcting signal Y_out′ according to the correcting coefficient Q_final, so as to output the image output signal Y_out. A sequence for serially connecting the first false contour reduction device 122 and the second false contour reduction device 124 is not limited only to what depicted in FIG. 2. For example, in other embodiments, an input terminal of the second false contour reduction device 124 is capable of receiving the image input signal Y_in and a chroma signal CbCr_in; an output ten final of the second false contour reduction device 124 may output the first image correcting signal to an input terminal of the first false contour reduction device 122; and an output terminal of the first false contour reduction device 122 outputs the image output signal Y_out. In the embodiment depicted in FIG. 2, detailed description regarding a specific implementation of the false contour reduction is provided below by using the first false contour reduction device 122 in FIG. 10 as an example.

FIG. 10 is a block diagram illustrating inside of the first false contour reduction device 122 of FIG. 2 according to an embodiment of the invention. In the present embodiment, the image input signal Y_in includes a luma signal. The first false contour reduction device 122 includes a horizontal filtering unit 122_2, a dithering unit 122_4, a horizontal edge detecting unit 122_6 and a blending unit 122_8, but the invention is not limited thereto. The horizontal filtering unit 122_2 is configured to determine whether a difference between a current pixel (e.g., the current pixel Y_{c} depicted in FIG. 8a) in the image input signal Y_in and an adjacent pixel (e.g., the adjacent pixel Y_{c+i}, where i is an integer) on a horizontal direction is greater than the correcting coefficient Q_final, thereby correspondingly outputting a filtered signal Y_lpf_out according to a determining result.

For instance, in some embodiments, the horizontal filtering unit 122_2 may include an edge preserved processor and a low pass filter (not illustrated). A first input terminal and a second input terminal of the edge preserved processor respectively receive the correcting coefficient Q_final and the image input signal Y_in. An output terminal of the edge preserved processor is coupled to an input terminal of the low pass filter. An output terminal of the low pass filter outputs the filtered signal Y_lpf_out to an input terminal of the dithering unit 122_4. The low pass filter may be a low pass filter circuit of any types, such as a traditional low pass filter and the like. The edge preserved processor is capable of determining whether the difference between the current pixel Y_{c} in the image input signal Y_in and the adjacent pixel Y_{c+i} on the horizontal direction is greater than the correcting coefficient Q_final, thereby deciding whether to adjust the luma signal of the adjacent pixel Y_{c+i} of the current pixel Y_{c} on the horizontal direction, and outputting an adjusted luma signal ′Y to the low pass filter. More specifically, when the difference between the current pixel Y_{c} in the image input signal Y_in and the adjacent pixel Y_{c+i} on the horizontal direction is greater than the correcting coefficient Q_final, the edge preserved processor may transfer the adjacent pixel Y_{c+i} on the horizontal direction into pixel values of the current pixel Y_{c}; and if a result of that determination is no, the edge preserved processor does not change pixel values of the adjacent pixel Y_{c+i} on the horizontal direction. Operations of the edge preserved processor is described in pseudo codes as follows with reference to FIG. 8a:

for (i = −n; i<=n, i++)
{

if ((Y_{c+i} − Y_{c})>Q_final)

′Y_{c+i} = Y_{c};

else

′Y_{c+i} = Y_{c+i};

}

Subsequently, the edge preserved processor outputs the adjusted luma signal ′Y to the low pass filter. For instance, the edge preserved processor may output the adjusted luma signals ′Y_{c-n} to ′Y_{c+n} of the adjacent pixel near the current pixel Y_{c} on the horizontal direction to a 2n+1 taps low pass filter. This 2n+1 taps low pass filter filters the adjusted luma signals ′Y_{c-n} to ′Y_{c+n}, thereby outputting the filtered signal Y_lpf_out to the dithering unit 122_4 at next stage.

The dithering unit 122_4 is coupled to the horizontal filtering unit 122_2, and configured to receive the filtered signal Y_lpf_out and perform a dithering operation to the filtered signal Y_lpf_out, so as to output a dithered signal Y_lpf_out′. The dithering operation is a technology in image processing which is related to visual illusion of human eyes with respective to an average color on a small region. A specific implementation of the dithering operation is to, in a palette system with limited colors, approximate a color which is not included in the palette system through diffusion. Therefore, a depth of the color after the dithering operation may be increased to make a quality of an image seem better. The dithering unit 122_4 may be a dithering circuit of any types, such as a traditional dithering circuit or the like.

Meanwhile, the horizontal edge detecting unit 122_6 in the first false contour reduction device 122 is configured to receive the image input signal Y_in and the chroma signal CbCr_in and detect a horizontal edge level H_edge_level according to the image input signal Y_in and the chroma signal CbCr_in, thereby deciding a horizontal valid value hlpf_coef. More specifically, the horizontal edge detecting unit 122_6 may calculate a horizontal gradient of Y, a horizontal gradient of Cb and a horizontal gradient of Cr for the current pixel Yc, and then select a largest one among the horizontal gradient of Y, the horizontal gradient of Cb and the horizontal gradient of Cr to be used as the horizontal edge level H_edge_level. Referring to FIG. 11 first, FIG. 11 is a look up table of a horizontal edge detecting unit according to an embodiment of the invention. In the present embodiment, the horizontal edge detecting unit 122_6 may compare the horizontal edge level H_edge_level with a plurality of horizontal edge thresholds (e.g., h_edge_th0, h_edge_th1, h_edge_th2, h_edge_th3), so as to quantize the horizontal edge level H_edge_level to obtain the horizontal valid value hlpf_coef (e.g., Coef0, Coef1, Coef2, Coef3), as shown in FIG. 11. Operations of deciding the horizontal valid value hlpf_coef is described in pseudo codes as follows with reference to FIG. 11:

H_edge_level = max(H Gradient of Y, H Gradient of Cb, H Gradient of
Cr)
{

if (H_edge_level > h_edge_th1)

hlpf_coef = Coef3;

else if (H_edge_level > h_edge_th2)

hlpf_coef = Coef2;

else if (H_edge_level > h_edge_th3)

hlpf_coef = Coef1;

else

hlpf_coef = Coef0;

}

In the present embodiment, the image input signal Y_in includes a luma signal (Y), and the chroma signal CbCr_in includes a read chroma signal (Cr) and a blue chroma signal (Cb). In above pseudo codes, H Gradient represents the horizontal gradient. The horizontal edge detecting unit 122_6 may select the largest one among the horizontal gradient of the luma signal Y, the horizontal gradient of the red chroma signal Cr and the horizontal gradient of the blue chroma signal Cb to be used as the horizontal edge level H_edge_level.

Lastly, returning to FIG. 10, the blending unit 122_8 is coupled to the dithering unit 122_4 and the horizontal edge detecting unit 122_6, and configured to perform a weight calculation to the image input signal Y_in and the dithered signal Y_lpf_out′, thereby outputting the first image correcting signal Y_out′. In the present embodiment, the blending unit 122_8 may decide weights of the image input signal Y_in and the dithered signal Y_lpf_out′ according to the horizontal valid value hlpf_coef. For instance, in some embodiments, the blending unit 122_8 may perform a calculation of “Y_out′=hlpf_coef*Y_lpf_out′+(1−hlpf_coef)*Y_in”, so as to obtain the first image correcting signal Y_out′.

Similarly, in the resent embodiment, inner elements and operating method of the second false contour reduction device 124 are both similar to the same in the first false contour reduction device 122. A major difference between the first false contour reduction device 122 and the second false contour reduction device 124 is that: the second false contour reduction device 124 mainly performs the calculation on the vertical direction, which may be may be inferred with reference to related description in FIG. 10. For instance, FIG. 12 is a block diagram illustrating inside of a second false contour reduction device 124 of FIG. 2 according to an embodiment of the invention. In the present embodiment, the second false contour reduction device 124 includes a vertical filtering unit 124_2, a dithering unit 124_4, a vertical edge detecting unit 124_6 and a blending unit 124_8, but the invention is not limited thereto. The vertical filtering unit 124_2 is configured to determine whether a difference between a current pixel (e.g., the current pixel Y_{c} depicted in FIG. 8b) in the first image correcting signal Y_out′ and an adjacent pixel (e.g., the adjacent pixel Y_{c+i} depicted in FIG. 8b, where i is an integer) on a vertical direction is greater than the correcting coefficient Q_final, thereby correspondingly outputting a filtered signal to the dithering unit 124_4 according to a determining result. Related description of the dithering unit 124_4 depicted in FIG. 12 may be inferred with reference to the dithering unit 122_4, which is not repeated hereinafter.

In some embodiments, the vertical filtering unit 124_2 may include an edge preserved processor and a low pass filter. A first input terminal and a second input terminal of the edge preserved processor respectively receive the correcting coefficient Q_final and the first image correcting signal Y_out′. An output terminal of the edge preserved processor is coupled to an input terminal of the low pass filter. An output terminal of the low pass filter outputs the filtered signal to an input terminal of the dithering unit 122_4. The low pass filter may be a low pass filter circuit of any types, such as a traditional low pass filter and the like. The edge preserved processor is capable of determining whether the difference between the current pixel Y_{c} in the first image correcting signal Y_out′ and the adjacent pixel Y_{c+i} on the vertical direction is greater than the correcting coefficient Q_final, thereby deciding whether to adjust the luma signal of the adjacent pixel Y_{c+i} of the current pixel Y_{c} on the vertical direction, and outputting an adjusted luma signal ′Y to the low pass filter. More specifically, when the difference between the current pixel Y_{c} in the first image correcting signal Y_out′ and the adjacent pixel Y_{c+i} on the vertical direction is greater than the correcting coefficient Q_final, the edge preserved processor may transfer the adjacent pixel Y_{c+i} on the vertical direction into pixel values of the current pixel Y_{c}; and if a result of that determination is no, the edge preserved processor does not change pixel values of the adjacent pixel Y_{c+}, on the vertical direction. Operations of the edge preserved processor is described in pseudo codes as follows with reference to FIG. 8b:

for (i = −n; i<=n, i++)
{

if ((Y_{c+i} − Y_{c})>Q_final)

′Y_{c+i} = Y_{c};

else

′Y_{c+i} = Y_{c+i};

}

Subsequently, the edge preserved processor in the vertical filtering unit 124_2 outputs the adjusted luma signal ′Y to the low pass filter. For instance, the edge preserved processor may output the adjusted luma signals ′Y_{c-n} to ′Y_{c+n} of the adjacent pixel near the current pixel Y_{c} on the vertical direction to a 2n+1 taps low pass filter. This 2n+1 taps low pass filter filters the adjusted luma signals ′Y_{c-n} to ′Y_{c+n} thereby outputting the filtered signal to the dithering unit 124_4. The dithering unit 124_4 performs a dithering operation to the filtered signal, so as to output a dithered signal to the blending unit 124_8.

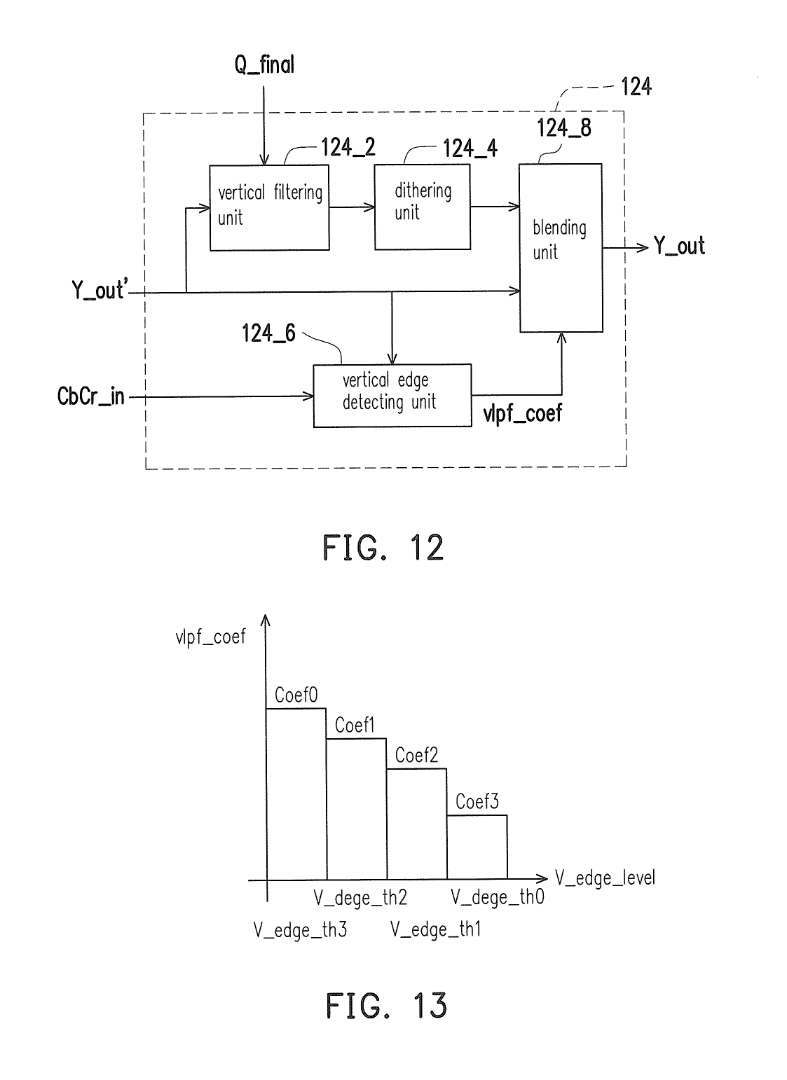

Meanwhile, the vertical edge detecting unit 124_6 in the second false contour reduction device 124 is configured to receive the first image correcting signal Y_out′ and the chroma signal CbCr_in and detect a vertical edge level V_edge_level according to the first image correcting signal Y_out′ and the chroma signal CbCr_in, thereby deciding a vertical valid value vlpf_coef. More specifically, the vertical edge detecting unit 124_6 may calculate a vertical gradient of Y, a vertical gradient of CbCb and a horizontal gradient of Cr for the current pixel Yc, and then select a largest one among the vertical gradient of Y, the vertical gradient of Cb and the vertical gradient of Cr to be used as the vertical edge level V_edge_level. FIG. 13 is a look up table of a vertical edge detecting unit according to an embodiment of the invention. In the present embodiment, the vertical edge detecting unit 124_6 may compare the vertical edge level V_edge_level with a plurality of vertical edge thresholds (e.g., v_edge_th0, v_edge_th1, v_edge_th2, v_edge_th3), so as to quantize the vertical edge level V_edge_level to obtain the vertical valid value vlpf_coef (e.g., Coef0, Coef1, Coef2, Coef3), as shown in FIG. 13. Operations of deciding the vertical valid value vlpf_coef is described in pseudo codes as follows with reference to FIG. 13:

V_edge_level = max(VGradient of Y, V Gradient of Cb, V Gradient of
Cr)
{

if (V_edge_level >v_edge_th1)

vlpf_coef = Coef3;

else if (V_edge_level >v_edge_th2)

vlpf_coef = Coef2;

else if (V_edge_level >v_edge_th3)

vlpf_coef = Coef1;

else

vlpf_coef = Coef0;

}

In the embodiment depicted in FIG. 12, the first image correcting signal Y_out′ includes a luma signal (Y), and the chroma signal CbCr_in includes a read chroma signal (Cr) and a blue chroma signal (Cb). In above pseudo codes, VGradient represents the vertical gradient. The vertical edge detecting unit 124_6 may select the largest one among the vertical gradient of the luma signal Y, the vertical gradient of the red chroma signal Cr and the vertical gradient of the blue chroma signal Cb to be used as the vertical edge level V_edge_level.

Lastly, returning to FIG. 12, the blending unit 124_8 is coupled to the dithering unit 124_4 and the vertical edge detecting unit 124_6, and configured to perform a weight calculation to the first image correcting signal Y_out′ and the dithered signal outputted by the dithering unit 124_4, thereby outputting the image output signal Y_out. In the present embodiment, the blending unit 124_8 may decide the weights of the first image correcting signal Y_out′ and the filtered signal outputted by the dithering unit 124_4 according to the vertical valid value vlpf_coef outputted by the vertical edge detecting unit 124_6. Related description of the blending unit 124_8 depicted in FIG. 12 may be inferred with reference to the blending unit 122_8, which is not repeated hereinafter.

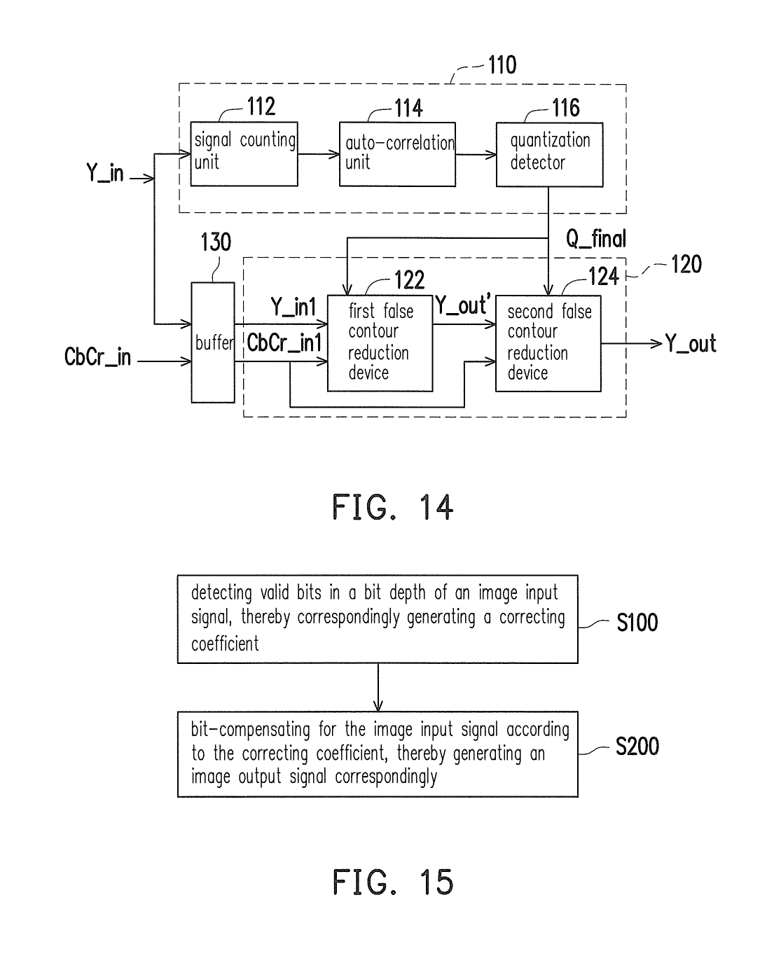

FIG. 14 is a block diagram illustrating internal circuits of the valid bits detector 110 and the compensator 120 depicted in FIG. 1 according to another embodiment of the invention. The embodiment depicted in FIG. 14 may be inferred with reference to related description for FIG. 2. Referring to FIG. 14, the valid bits detector 110 of present embodiment includes a signal counting unit 112, an auto-correlation unit 114 and a quantization detector 116, but the invention is not limited thereto. A difference between the present embodiment and the embodiment of FIG. 2 is that, under circumstances where it is not required to further identify whether the image input signal is the nature image or the graphic image, the valid bits detector 100 depicted in FIG. 14 may not include the graphic meter 118, instead, the initial correcting coefficient Q calculated by the quantization detector 116 may directly serve as the correcting coefficient Q_final to be transmitted to the compensator 120. The rest of elements may refer to related descriptions of FIG. 2, which are not repeated hereinafter.

Further, it should be note that, the correcting coefficient Q_final outputted by the valid bits detector 110 has one frame which is delayed with respect to the image input signal Y_in. Therefore, in the embodiment depicted in FIG. 14, the image processing device 100 may further include a buffer 130. An output terminal of the buffer 130 is coupled to an input terminal of the compensator 120, and configured to buffer the image input signal Y_in and the chroma signal CbCr_in, for synchronizing the buffered image input signal Y_in1 (the chroma signal CbCr_in1) with the correcting coefficient Q_final, and inputting the buffered image input signal Y_in1 and the chroma signal CbCr_in1 to the compensator 120. However, the invention is not limited thereto.

With regard to a correcting method for the image processing device 100 according to the present embodiment of the invention, for clarity of the description, the correcting method of the image processing device 100 according to the different embodiment of the invention is described with reference to the elements of the image processing device 100 in FIG. 1, FIG. 2 (or FIG. 14) and FIG. 10.

FIG. 15 is a flowchart of an image processing method according to an embodiment of the invention. Referring to FIG. 1 and FIG. 15, first, the valid bits detector 110 detects valid bits in a bit depth of an image input signal Y_in, thereby correspondingly generating a correcting coefficient Q_final to the compensator 120 (step S100). Subsequently, the compensator 120 bit-compensates for the image input signal Y_in according to the correcting coefficient Q_final, thereby outputting an image output signal Y_out correspondingly (step S200).

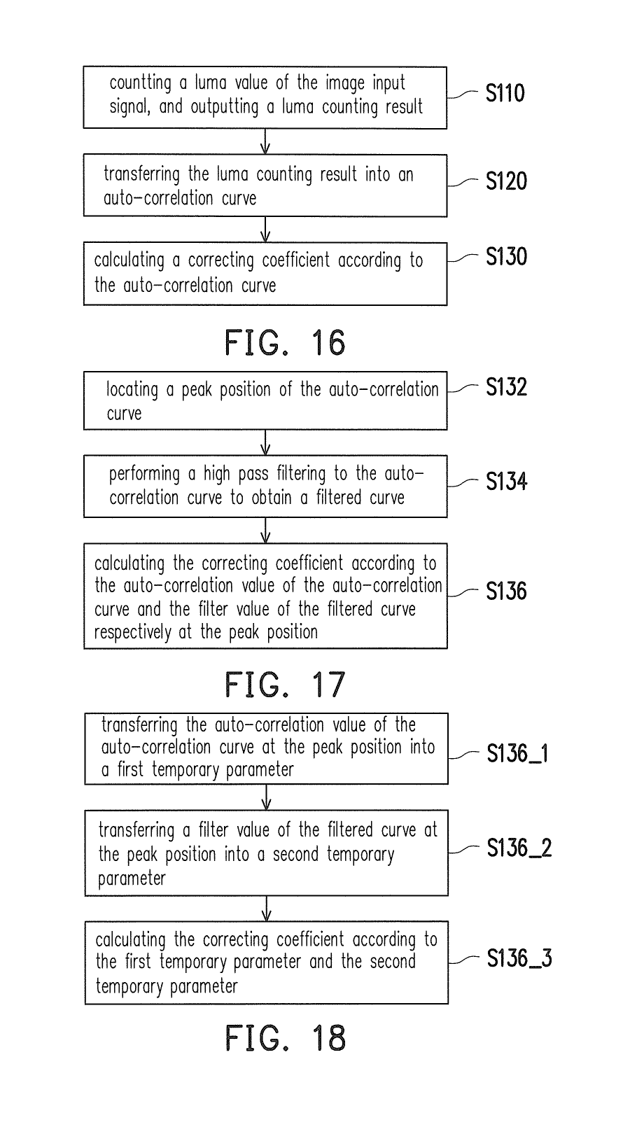

FIG. 16 is a flowchart of step S100 in FIG. 15 according to an embodiment of the invention. In the present embodiment, step S100 includes sub-steps S110 to S130. Referring to FIG. 14, FIG. 3 to FIG. 5, and FIG. 16 together, the signal counting unit 112 counts a luma value of the image input signal Y_in, and outputs a luma counting result (step S110). Subsequently, the auto-correlation unit 114 transfers the luma counting result into an auto-correlation curve 400 (step S120). The quantization detector 116 calculates an initial correcting coefficient Q according to the auto-correlation curve 400, and uses the initial correcting coefficient Q to be used as the correcting coefficient Q_final to be transmitted to the compensator 120 (step S130).

FIG. 17 is a flowchart of step S130 in FIG. 16 according to an embodiment of the invention. In the present embodiment, step S130 includes sub-steps S132 to S136. Referring to FIG. 4, FIG. 14 ad FIG. 17 together, the quantization detector 116 locates a peak position of the auto-correlation curve 400 (e.g., Q1) in step S132. Subsequently, the quantization detector 116 performs a high pass filtering to the auto-correlation curve 400 to obtain a filtered curve 500 in step S134 (referring to the related description of FIG. 5). The quantization detector 116 calculates the initial correcting coefficient Q according to the auto-correlation value R1 of the auto-correlation curve 400 and the filter value K1 of the filtered curve 500 respectively at the peak position Q1, and uses the initial correcting coefficient Q to be used as the correcting coefficient Q_final to be transmitted to the compensator 120 (step S136).

FIG. 18 is a flowchart of step S136 in FIG. 17 according to an embodiment of the invention. In the present embodiment, step S136 includes sub-steps S136_1 to S136_3. In step S136_1 of the present embodiment, the quantization detector 116 transfers the auto-correlation value R1 of the auto-correlation curve 400 at the peak position Q1 into a first temporary parameter Q_tmp1 (referring to related description of FIG. 6a). Subsequently, the quantization detector 116 transfers a filter value K1 of the filtered curve 500 at the peak position Q1 into a second temporary parameter Q_tmp2 in step S136_2 (referring to related description of FIG. 6b). The quantization detector 116 depicted in FIG. 14 calculates an initial correcting coefficient Q according to the first temporary parameter Q_tmp1 and the second temporary parameter Q_tmp2, and uses the initial correcting coefficient Q to be used as the correcting coefficient Q_final to be transmitted to the compensator 120 (step S136_3).

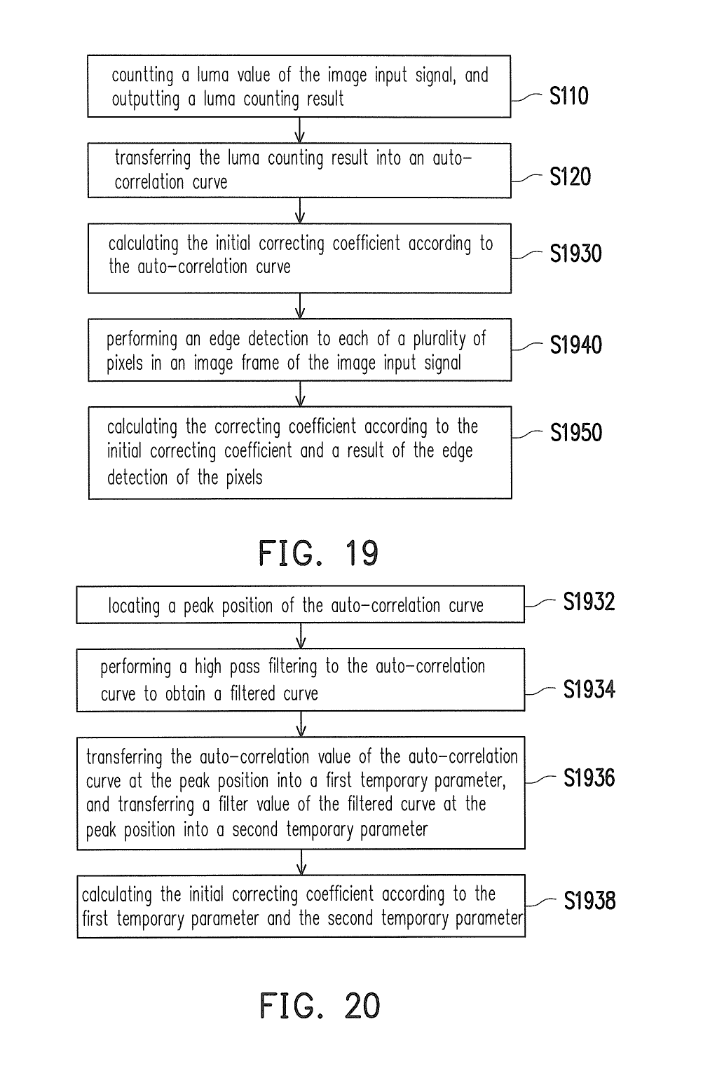

FIG. 19 is a flowchart of step S100 in FIG. 15 according to another embodiment of the invention. Steps S110, S120 and S1930 depicted in FIG. 19 may be inferred with reference to related description of steps S110, S120 and S1930 depicted in FIG. 16. Referring to FIG. 2 and FIG. 19 together, in the resent embodiment, the valid bits detector 110 further includes a graphic meter 118. In step S1930, the quantization detector 116 calculates the initial correcting coefficient Q, and transmits the initial correcting coefficient Q to the graphic meter 118. The graphic meter 118 in the valid bits detector 110 performs an edge detection to each of a plurality of pixels in an image frame of the image input signal Y_in (step S1940), and calculates the correcting coefficient Q_final according to the initial correcting coefficient Q and a result of the edge detection of the pixels (step S1950). The initial correcting coefficient Q is multiplied by a first correcting gain Q_gain1 and the second correcting gain Q_gain2 to obtain the correcting coefficient Q_final (step S1950).

FIG. 20 is a flowchart of step S1930 in FIG. 19 according to an embodiment of the invention. In the present embodiment, step S1930 includes sub-steps S1932 to S1938. Steps S1932 and S1934 depicted in FIG. 20 may be inferred with reference to related description of steps S132 and S134 depicted in FIG. 17. Steps S1936 and S1938 depicted in FIG. 20 may be inferred with reference to related description of steps S136_1, S136_2 and S136_3 depicted in FIG. 18. Therefore, in step S1938, the quantization detector 116 depicted in FIG. 2 may calculate the initial correcting coefficient Q according to the first temporary parameter Q_tmp1 and the second temporary parameter Q_tmp2 and transmits the initial correcting coefficient Q to the graphic meter 118.

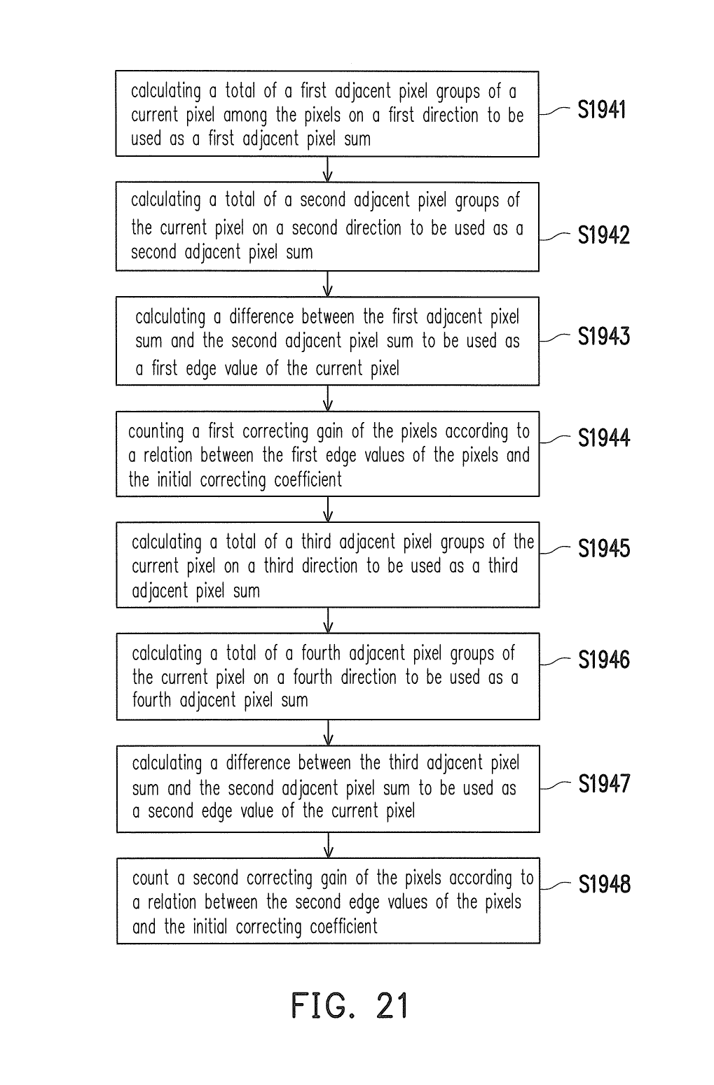

FIG. 21 is a flowchart of step S1940 in FIG. 19 according to an embodiment of the invention. In the present embodiment, step S1940 includes sub-steps S1941 to S1948. Referring to FIG. 2 and FIG. 21 together, in step S1941 of the present embodiment, the graphic meter 118 calculates a total of a first adjacent pixel groups Y_{c-n}, Y_{c-n+i}, . . . , Y_{c-1} of a current pixel Y_{c} among the pixels on a first direction (e.g., the row direction or the horizontal direction, referring to related descriptions of FIG. 7 and FIG. 8a) to be used as a first adjacent pixel sum

$${\sum }_{i = 1}^{n} {Y}_{c - i} .$$

Subsequently, in step S1942, the graphic meter 118 calculates a total of a second adjacent pixel groups Y_{c+1}, . . . , Y_{c+n-1}, Y_{c+n} of the current pixel Y_{c} on a second direction to be used as a second adjacent pixel sum

$${\sum }_{i = 1}^{n} {Y}_{c + i} .$$

Therein, the first direction and the second direction have a difference of 180 degree. Subsequently, in step S1943, the graphic meter 118 calculates a difference between the first adjacent pixel sum

$${\sum }_{i = 1}^{n} {Y}_{c - i}$$

and the second adjacent pixel sum

$${\sum }_{i = 1}^{n} {Y}_{c + i}$$

to be used as a first edge value of the current pixel Y_{c}. Take FIG. 7 for example, the graphic meter 118 may calculate the first edge value of the current pixel Y_{x,y} being

$${Yhdiff}_{x , y} = \vert {\sum }_{j = y - 4}^{y - 1} {Y}_{x , j} - {\sum }_{j = y + 1}^{y + 4} {Y}_{x , j} \vert$$

in step S1943. In step S1944, the graphic meter 118 may count a first correcting gain Q_gain1 of the pixels according to a relation between the first edge values of the pixels and the initial correcting coefficient Q.

Similarly, referring to FIG. 8b, in step S1945, the graphic meter 118 may calculate a total of a third adjacent pixel groups Y_{c-n}, Y_{c-n+1}, . . . , Y_{c-1} of the current pixel Y_{c} on a third direction (e.g., the column direction or the vertical direction) to be used as a third adjacent pixel sum

$${\sum }_{i = 1}^{n} {Y}_{c - i} .$$

In step S1946, the graphic meter 118 may also calculate a total of a fourth adjacent pixel groups Y_{c+1}, . . . , Y_{c+n-1}, Y_{c+n} of the current pixel Y_{c} on a fourth direction to be used as a fourth adjacent pixel sum

$${\sum }_{i = 1}^{n} {Y}_{c + i} .$$

Therein, the third direction and the fourth direction have a difference of 181 degree. Subsequently, in step S1947, the graphic meter 118 calculates a difference between the third adjacent pixel sum

$${\sum }_{i = 1}^{n} {Y}_{c - i}$$

and the second adjacent pixel sum

$${\sum }_{i = 1}^{n} {Y}_{c + i}$$

to be used as a second edge value of the current pixel Y_{c}. Take FIG. 7 for example, the graphic meter 118 may calculate the second edge value of the current pixel Y_{x,y} being

$${Yvdiff}_{x , y} = \vert {\sum }_{i = x - 4}^{x - 1} {Y}_{i , y} - {\sum }_{i = x + 1}^{x + 4} {Y}_{i , y} \vert$$

in step S1947. In step S1948, the graphic meter 118 may count a second correcting gain Q_gain2 of the pixels according to a relation between the second edge values of the pixels and the initial correcting coefficient Q.

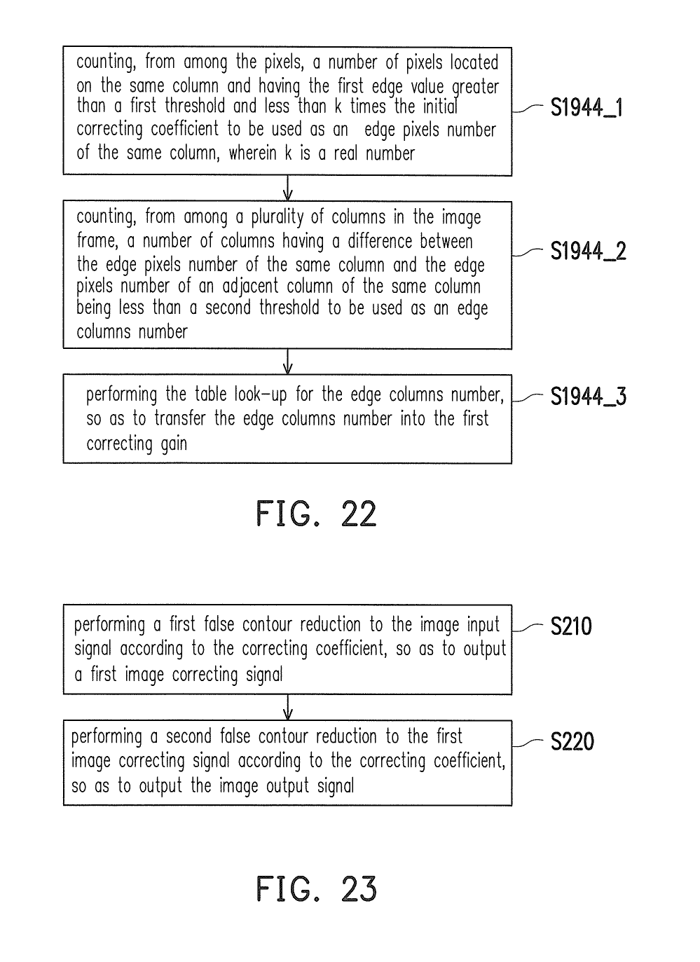

FIG. 22 is a flowchart of step S1944 in FIG. 21 according to an embodiment of the invention. In the present embodiment, step S1944 includes sub-steps S1944_1 to S1944_3. In step S1944_1, the graphic meter 118 counts, from among the pixels, a number of pixels located on the same row and having the first edge value Yhdiff_{x,y} greater than a first threshold N and less than k times the initial correcting coefficient Q to be used as a horizontal edge pixels number of the same row, wherein k is a real number (e.g., 4 or other numbers). For instance, the graphic meter 118 may count a number of pixels matching a condition of “(the first edge value Yhdiff_{i,j}>N) and (the first edge value Yhdiff_{i,j}<k*Q)ⁿ of an i^{th} row in the image frame depicted in FIG. 7 to be used as the horizontal edge pixels number contour_h_cntᵢ of the i^{th} row. Subsequently, in step S1944_2, the graphic meter 118 counts, from among a plurality of rows in the image frame, a number of rows having a difference between the horizontal edge pixels number of one row and the horizontal edge pixels number of an adjacent row being less than a second threshold th_h to be used as a horizontal edge rows number Graphic_h_level. For instance, the graphic meter 118 may count a number of rows matching a condition of “|contour_h_cntᵢ−contour_h_cntᵢ₊₁|<th_h” in the image frame depicted in FIG. 7 from a first row to a vcnt^{th} row to be used as the horizontal edge rows number Graphic_h_level of the image frame. In step S1944_3, the graphic meter 118 performs the table look-up for the horizontal edge rows number Graphic_h_level (e.g., referring to related description of FIG. 9a), so as to transfer the horizontal edge rows number Graphic_h_level into the first correcting gain Q_gain1.

Similarly, in step S1948 depicted in FIG. 21, the graphic meter 118 may count, from among the pixels in the image frame, a number of pixels located on the same row and having the second edge value greater than the first threshold N and less than k times the initial correcting coefficient Q to be used as a vertical edge pixels number of the same row. For instance, the graphic meter 118 may count a number of pixels matching a condition of “(the second edge value Yvdiff_{i,j}>N) and (second edge value Yvdiff_{i,j}<k*Q)” of an i^{th} row in the image frame depicted in FIG. 7 to be used as the vertical edge pixels number contour_v_cntᵢ of the i^{th} row. In step S1948, the graphic meter 118 counts, from among a plurality of rows in the image frame, a number of rows having a difference between the vertical edge pixels number of one row and the vertical edge pixels number of an adjacent row being less than a second threshold th_h to be used as a vertical edge rows number Graphic_v_level. For instance, the graphic meter 118 may count a number of rows matching a condition of “|contour_v_cntᵢ−contour_v_cntᵢ₊₁|<th_h” in the image frame depicted in FIG. 7 from a first row to a vcnt^{th} row to be used as the vertical edge rows number Graphic_v_level of the image frame. In step S1948, the graphic meter 118 performs is the table look-up for the vertical edge rows number Graphic_v_level, so as to transfer the vertical edge rows number Graphic_v_level into the second correcting gain Q_gain2.

FIG. 23 is a flowchart of step S200 in FIG. 15 according to an embodiment of the invention. In the present embodiment, step S200 includes sub-steps S210 to S220. Referring to FIG. 2 and FIG. 23 together, a first false contour reduction device 122 in the compensator 120 performs a first false contour reduction to the image input signal Y_in according to the correcting coefficient Q_final, so as to output a first image correcting signal Y_out′ (step S210). Subsequently, a second false contour reduction device 124 in the compensator 120 performs a second false contour reduction to the first image correcting signal Y_out′ according to the correcting coefficient Q_final, so as to output the image output signal Y_out (step S220).

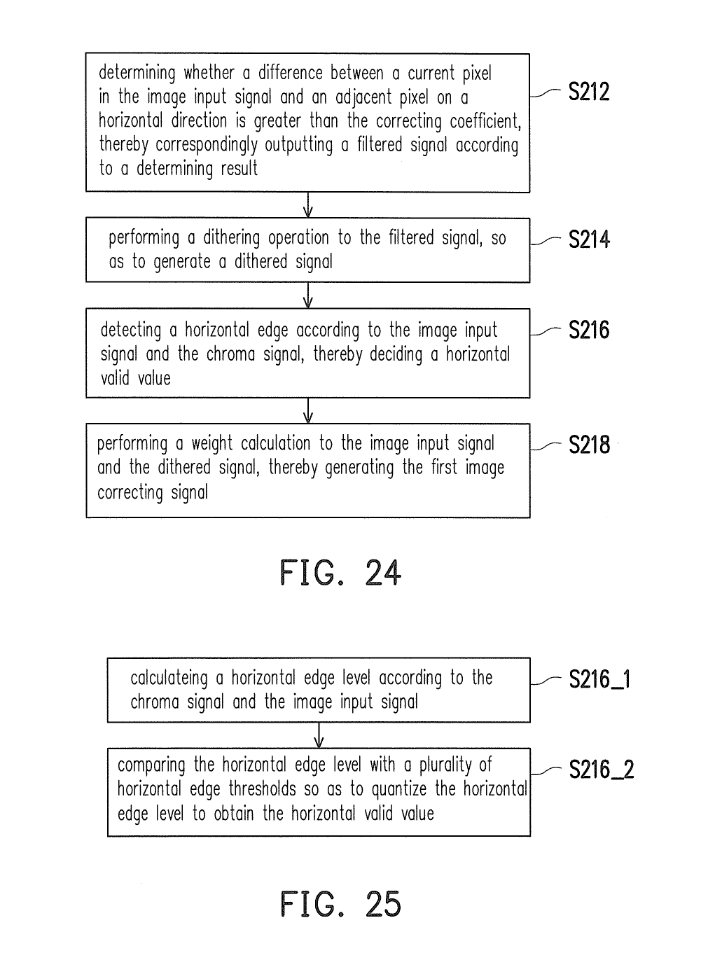

FIG. 24 is a flowchart of step S210 in FIG. 23 according to an embodiment of the invention. In the present embodiment, step S210 includes sub-steps S212 to S218. Referring to FIG. 2, FIG. 8a, FIG. 10, and FIG. 24, the horizontal filtering unit 122_2 determines whether a difference between a current pixel Y_{c} in the image input signal Y_in and an adjacent pixel Y_{c+i} on a horizontal direction is greater than the correcting coefficient Q_final, thereby correspondingly outputting a filtered signal Y_lpf_out according to a determining result (step S212). Subsequently, the dithering unit 122_4 performs a dithering operation to the filtered signal, so as to generate a dithered signal Y_lpf_out′ (step S214). The horizontal edge detecting unit 122_6 detects a horizontal edge according to the image input signal Y_in and the chroma signal CbCr_in, thereby deciding a horizontal valid value hlpf_coef (step S216). The blending unit 122_8 performs a weight calculation to the image input signal Y_in and the dithered signal Y_lpf_out′ according to the horizontal valid value hlpf_coef, thereby generating the first image correcting signal Y_out′ (step S218).

FIG. 25 is a flowchart of step S216 in FIG. 24 according to an embodiment of the invention. In the present embodiment, step S216 includes sub-steps S216_1 to S216_2. Referring to FIG. 2, FIG. 10, FIG. 11 and FIG. 25, the horizontal edge detecting unit 122_6 calculates a horizontal edge level H_edge_level according to the chroma signal CbCr_in and the image input signal Y_in (step S216_1). The horizontal edge detecting unit 122_6 compares the horizontal edge level with a plurality of horizontal edge thresholds (e.g., h_edge_th0, h_edge_th1, h_edge_th2, h_edge_th4) so as to quantize the horizontal edge level to obtain the horizontal valid value hlpf_coef (step S216_2).

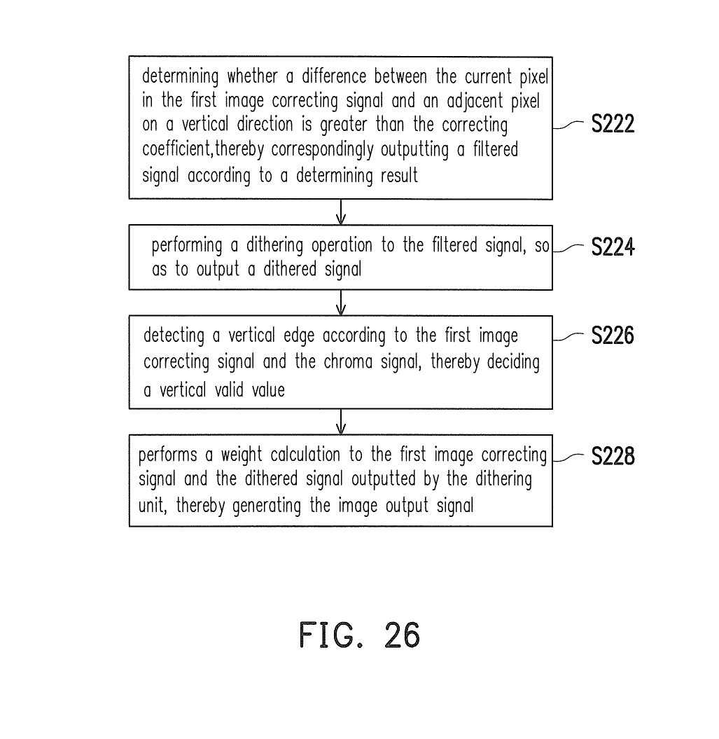

Similarly, FIG. 26 is a flowchart of step S220 in FIG. 23 according to an embodiment of the invention. In the present embodiment, step S220 includes sub-steps S222 to S228. Referring to FIG. 2, FIG. 8a, FIG. 12, and FIG. 26, the vertical filtering unit 124_2 determines whether a difference between the current pixel Y_{c} in the first image correcting signal Y_out′ and an adjacent pixel Y_{c+i} on a vertical direction is greater than the correcting coefficient Q_final, thereby correspondingly outputting a filtered signal according to a determining result to the dithering unit 124_4 (step S222). Subsequently, the dithering unit 124_4 performs a dithering operation to the filtered signal, so as to generate a dithered signal to the vertical edge detecting unit 124_6 (step S224). The vertical edge detecting unit 124_6 detects a vertical edge according to the first image correcting signal Y_out′ and the chroma signal CbCr_in, thereby deciding a vertical valid value vlpf_coef (step S226). The blending unit 124_8 performs a weight calculation to the first image correcting signal Y_out′ and the dithered signal outputted by the dithering unit 124_4 according to the vertical valid value vlpf_coef, thereby generating the image output signal Y_out (step S228).

In summary, in the image processing device and the method thereof as proposed according to the embodiments of the invention, the valid bits detector 110 in the image processing device 100 may detect the valid bits in the bit depth of the image input signal Y_in, and perform processes and calculations to the image input signal Y_in, so as to output the obtained correcting coefficient Q_final to the compensator 120. The compensator 120 bit-compensates for insufficient bit depth of the image input signal Y_in according to the correcting coefficient Q_final, thereby effectively improving a display quality of the image frame being displayed while avoiding occurrences of the false contour phenomenon.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. An image processing device, comprising:
a valid bits detector, configured to detect valid bits of an image input signal thereby outputting a correcting coefficient correspondingly; and
a compensator, coupled to the valid bits detector to receive the correcting coefficient, bit-compensating for the image input signal according to the correcting coefficient thereby outputting an image output signal correspondingly.

2. The image processing device of claim 1, wherein the valid bits detector comprises:
a signal counting unit, counting a luma value of the image input signal, and outputting a luma counting result;
an auto-correlation unit, coupled to the signal counting unit, and configured to transfer the luma counting result into an auto-correlation curve; and
a quantization detector, coupled to the auto-correlation unit, and configured to calculate the correcting coefficient according to the auto-correlation curve and output the correcting coefficient to the compensator.

3. The image processing device of claim 2, wherein the auto-correlation unit transfers the luma counting result into the auto-correlation curve according to a correlation function.

4. The image processing device of claim 2, wherein the quantization detector locates a peak position of the auto-correlation curve,
performs a high pass filtering to the auto-correlation curve to obtain a filtered curve, and
calculates the correcting coefficient according to an auto-correlation value of the auto-correlation curve and a filter value of the filtered curve respectively at the peak position.

5. The image processing device of claim 4, wherein the quantization detector
transfers the auto-correlation value of the auto-correlation curve at the peak position into a first temporary parameter,
transfers the filter value of the filtered curve at the peak position into a second temporary parameter, and
calculates the correcting coefficient according to the first temporary parameter and the second temporary parameter.

6. The image processing device of claim 5, wherein the quantization detector
multiplies the first temporary parameter by the second temporary parameter to obtain the correcting coefficient.

7. The image processing device of claim 1, wherein the valid bits detector comprises:
a signal counting unit, counting a luma value of the image input signal, and outputting a luma counting result;
an auto-correlation unit, coupled to the signal counting unit, and configured to transfer the luma counting result into an auto-correlation curve;
a quantization detector, coupled to the auto-correlation unit, and configured to calculate an initial correcting coefficient according to the auto-correlation curve; and
a graphic meter, coupled to the quantization detector to receive the initial correcting coefficient, configured to perform an edge detection to a plurality of pixels in an image frame of the image input signal and calculate the correcting coefficient according to the initial correcting coefficient and a result of the edge detection of the pixels.

8. The image processing device of claim 7, wherein the quantization detector locates a peak position of the auto-correlation curve,
performs a high pass filtering to the auto-correlation curve to obtain a filtered curve,
transfers an auto-correlation value of the auto-correlation curve at the peak position into a first temporary parameter,
transfers a filter value of the filtered curve at the peak position into a second temporary parameter, and
calculates the initial correcting coefficient according to the first temporary parameter and the second temporary parameter.

9. The image processing device of claim 7, wherein the edge detection comprises:
calculating a total of a first adjacent pixels group of a current pixel among the pixels on a first direction to be used as a first adjacent pixel sum;
calculating a total of a second adjacent pixels group of the current pixel on a second direction to be used as a second adjacent pixel sum, wherein the first direction and the second direction have a difference of 180 degree;
calculating a difference between the first adjacent pixel sum and the second adjacent pixel sum to be used as a first edge value of the current pixel;
counting a first correcting gain of the pixels according to a relation between the first edge values of the pixels and the initial correcting coefficient;
calculating a total of a third adjacent pixels group of the current pixel on a third direction to be used as a third adjacent pixel sum;
calculating a total of a fourth adjacent pixels group of the current pixel on a fourth direction to be used as a fourth adjacent pixel sum, wherein the third direction and the fourth direction have a difference of 180 degree;
calculating a difference between the third adjacent pixel sum and the fourth adjacent pixel sum to be used as a second edge value of the current pixel;
counting a second correcting gain of the pixels according to a relation between the second edge values of the pixels and the initial correcting coefficient; and
using the first correcting gain and the second correcting gain to be used as the result of the edge detection.

10. The image processing device of claim 9, wherein the operation of calculating the correcting coefficient comprises:
multiplying the initial correcting coefficient by the first correcting gain and the second correcting gain to obtain the correcting coefficient.

11. The image processing device of claim 1, wherein the compensator comprises:
a first false contour reduction device, configured to receive the image input signal and perform a first false contour reduction to the image input signal according to the correcting coefficient, so as to output a first image correcting signal; and
a second false contour reduction device, coupled to the first false contour reduction device, configured to receive the first image correcting signal and perform a second false contour reduction to the first image correcting signal according to the correcting coefficient, so as to output the image output signal.

12. The image processing device of claim 11, wherein the first false contour reduction device comprises:
a horizontal filtering unit, configured to determine whether a difference between a current pixel in the image input signal and an adjacent pixel on a horizontal direction is greater than the correcting coefficient, thereby correspondingly outputting a filtered signal according to a determining result;
a dithering unit, coupled to the horizontal filtering unit, and configured to receive the filtered signal and perform a dithering operation to the filtered signal, so as to output a dithered signal;
a horizontal edge detecting unit, configured to receive the image input signal and a chroma signal and detect a horizontal edge according to the image input signal and the chroma signal, thereby deciding a horizontal valid value; and
a blending unit, coupled to the dithering unit and the horizontal edge detecting unit, configured to perform a weight calculation to the image input signal and the dithered signal, thereby outputting the first image correcting signal, wherein the blending unit decides weights of the image input signal and the dithered signal according to the horizontal valid value.

13. The image processing device of claim 12, wherein the horizontal edge detecting unit
calculates a horizontal edge level according to the chroma signal and the image input signal, and
compares the horizontal edge level with a plurality of horizontal edge thresholds, so as to quantize the horizontal edge level to obtain the horizontal valid value.

14. The image processing device of claim 13, wherein the image input signal comprises a luma signal, the chroma signal comprises a red chroma signal and a blue chroma signal, and the horizontal edge detecting unit selects a largest one among a horizontal gradient of the luma signal, a horizontal gradient of the red chroma signal and a horizontal gradient of the blue chroma signal to be used as the horizontal edge level.

15. The image processing device of claim 11, wherein the second false contour reduction device comprises:
a vertical filtering unit, configured to determine whether a difference between a current pixel in the first image correcting signal and an adjacent pixel along a vertical direction is greater than the correcting coefficient, thereby correspondingly outputting a filtered signal according to a determining result;
a dithering unit, coupled to the vertical filtering unit, and configured to receive the filtered signal and perform a dithering operation to the filtered signal, so as to output a dithered signal;
a vertical edge detecting unit, configured to receive the first image correcting signal and a chroma signal and detect a vertical edge according to the first image correcting signal and the chroma signal, thereby deciding a vertical valid value; and
a blending unit, coupled to the dithering unit and the vertical edge detecting unit, configured to perform a weight calculation to the first image correcting signal and the dithered signal, thereby outputting the image output signal, wherein the blending unit decides weights of the first image correcting signal and the dithered signal according to the vertical valid value.

16. The image processing device of claim 1, further comprising:
a buffer unit, configured to buffer the image input signal for synchronizing the image input signal with the correcting coefficient and inputting the buffered image input signal to the compensator.

17. An image processing method adapted to an image processing device, comprising:
detecting valid bits of an image input signal, thereby generating a correcting coefficient correspondingly; and
bit-compensating for the image input signal according to the correcting coefficient, thereby generating an image output signal correspondingly.

18. The image processing method of claim 17, wherein the step of detecting the valid bits of the image input signal, thereby generating the correcting coefficient correspondingly comprises:
counting a luma value of the image input signal, and outputting a luma counting result;
transferring the luma counting result into an auto-correlation curve; and
calculating the correcting coefficient according to the auto-correlation curve.

19. The image processing method of claim 18, wherein the step of transferring the luma counting result into the auto-correlation curve comprises:
transferring the luma counting result into the auto-correlation curve according to a correlation function.

20. The image processing method of claim 18, wherein the step of calculating the correcting coefficient comprises:
locating a peak position of the auto-correlation curve;
performing a high pass filtering to the auto-correlation curve to obtain a filtered curve; and
calculating the correcting coefficient according to an auto-correlation value of the auto-correlation curve and a filter value of the filtered curve respectively at the peak position.

21. The image processing method of claim 20, wherein the step of calculating the correcting coefficient according to the auto-correlation value and the filter value comprises:
transferring the auto-correlation value of the auto-correlation curve at the peak position into a first temporary parameter;
transferring the filter value of the filtered curve at the peak position into a second temporary parameter; and
calculating the correcting coefficient according to the first temporary parameter and the second temporary parameter.

22. The image processing method of claim 21, wherein the step of calculating the correcting coefficient according to the first temporary parameter and the second temporary parameter comprises:
multiplying the first temporary parameter by the second temporary parameter to obtain the correcting coefficient.

23. The image processing method of claim 17, wherein the step of detecting the valid bits of the image input signal, thereby generating the correcting coefficient correspondingly comprises:
counting a luma value of the image input signal, and outputting a luma counting result;
transferring the luma counting result into an auto-correlation curve;
calculating an initial correcting coefficient according to the auto-correlation curve; and
performing an edge detection to a plurality of pixels in an image frame of the image input signal, and calculating the correcting coefficient according to the initial correcting coefficient and a result of the edge detection of the pixels.

24. The image processing method of claim 23, wherein the step of calculating the initial correcting coefficient comprises:
locating a peak position of the auto-correlation curve;
performing a high pass filtering to the auto-correlation curve to obtain a filtered curve;
transferring an auto-correlation value of the auto-correlation curve at the peak position into a first temporary parameter;
transferring a filter value of the filtered curve at the peak position into a second temporary parameter; and
calculates the initial correcting coefficient according to the first temporary parameter and the second temporary parameter.

25. The image processing method of claim 24, wherein the edge detection comprises:
calculating a total of a first adjacent pixels group of a current pixel among the pixels on a first direction to be used as a first adjacent pixel sum;
calculating a total of a second adjacent pixels group of the current pixel on a second direction to be used as a second adjacent pixel sum, wherein the first direction and the second direction have a difference of 180 degree;
calculating a difference between the first adjacent pixel sum and the second adjacent pixel sum to be used as a first edge value of the current pixel;
counting a first correcting gain of the pixels according to a relation between the first edge values of the pixels and the initial correcting coefficient;
calculating a total of a third adjacent pixels group of the current pixel on a third direction to be used as a third adjacent pixel sum;
calculating a total of a fourth adjacent pixels group of the current pixel on a fourth direction to be used as a fourth adjacent pixel sum, wherein the third direction and the fourth direction have a difference of 180 degree;
calculating a difference between the third adjacent pixel sum and the fourth adjacent pixel sum to be used as a second edge value of the current pixel;
counting a second correcting gain of the pixels according to a relation between the second edge values of the pixels and the initial correcting coefficient; and
using the first correcting gain and the second correcting gain to be used as the result of the edge detection.

26. The image processing method of claim 25, wherein the step of calculating the correcting coefficient comprises:
multiplying the initial correcting coefficient by the first correcting gain and the second correcting gain to obtain the correcting coefficient.

27. The image processing method of claim 17, wherein the step of generating the image output signal correspondingly comprises:
performing a first false contour reduction to the image input signal according to the correcting coefficient, so as to output a first image correcting signal; and
performing a second false contour reduction to the first image correcting signal according to the correcting coefficient, so as to output the image output signal.

28. The image processing method of claim 27, wherein the first false contour reduction comprises:
determining whether a difference between a current pixel in the image input signal and an adjacent pixel on a horizontal direction is greater than the correcting coefficient, thereby correspondingly outputting a filtered signal according to a determining result;
performing a dithering operation to the filtered signal, so as to generate a dithered signal;
detecting a horizontal edge according to the image input signal and a chroma signal, thereby deciding a horizontal valid value; and
performing a weight calculation to the image input signal and the dithered signal, thereby generating the first image correcting signal, wherein weights of the image input signal and the dithered signal are decided according to the horizontal valid value.

29. The image processing method of claim 28, wherein the step of deciding the horizontal valid value comprises:
calculating a horizontal edge level according to the chroma signal and the image input signal; and
comparing the horizontal edge level with a plurality of horizontal edge thresholds, so as to quantize the horizontal edge level to obtain the horizontal valid value.

30. The image processing method of claim 29, wherein the image input signal comprises a luma signal, the chroma signal comprises a red chroma signal and a blue chroma signal, and the step of calculating the horizontal edge level comprises:
selecting a largest one among the a horizontal gradient of the luma signal, a horizontal gradient of the red chroma signal and a horizontal gradient of the blue chroma signal to be used as the horizontal edge level.

31. The image processing method of claim 27, wherein the second false contour reduction comprises:
determining whether a difference between a current pixel in the first image correcting signal and an adjacent pixel on a vertical direction is greater than the correcting coefficient, thereby correspondingly outputting a filtered signal according to a determining result;
performing a dithering operation to the filtered signal, so as to output a dithered signal;
detecting a vertical edge according to the first image correcting signal and a chroma signal, thereby deciding a vertical valid value; and
performing a weight calculation to the first image correcting signal and the dithered signal, thereby generating the image output signal, wherein weights of the first image correcting signal and the dithered signal are decided according to the vertical valid value.
